(19) United States
(12) Patent Application Publication
(10) Pub. No.: US 2026/0370863 A1
(43) Pub. Date: Nov. 19, 2026

(54) APPARATUS AND METHOD FOR PROVIDING INDICATION OF MACHINE CONSUMPTION PROPERTIES IN MEDIA BITSTREAMS

(71) Applicant: Nokia Technologies Oy, Espoo (FI)

(72) Inventors: Miska Matias HANNUKSELA, Tampere (FI); Francesco CRICRÌ, Tampere (FI); Honglei ZHANG, Tampere (FI)

(21) Appl. No.: 19/133,909

(22) PCT Filed: Dec. 20, 2023
(86) PCT No.: PCT/IB2023/063050

§ 371 Date: May 29, 2025

Related U.S. Application Data
(60) Provisional application No. 63/476,896, filed on Dec. 22, 2022.

(51) Int. Cl. H04N 19/46; H04N 19/124; H04N 19/14; H04N 19/31

(52) U.S. Cl. CPC H04N 19/46; H04N 19/124; H04N 19/14; H04N 19/31

(57) ABSTRACT

Various embodiments provide an apparatus, a method, and a computer program product. An example method includes: decoding from or along a bitstream an indication message indicating that a media decoded from the bitstream is inconsistent or incoherent for consumption by a user and/or the media decoded from the bitstream is intended for machine analysis; decoding or inferring that the media decoded from the bitstream is within the scope of the indication message; decoding from the indication message whether the media decoded from the bitstream within the scope is intended for machine vision tasks and/or is intended for consumption by the user; and in response to the decoding from the indication message, serving the media decoded from the bitstream within the scope to a machine task and/or displaying the media decoded from the bitstream within the scope to the user.

### TECHNICAL FIELD

The examples and non-limiting embodiments relate generally to multimedia transport and neural networks, and more particularly, to method, apparatus, and computer program product for providing or receiving indication of machine consumption properties in media bitstreams.

### BACKGROUND

It is known to provide media for machine consumption.

### SUMMARY

Example 1: A method including: analyzing a media; and encoding in or along a bitstream the media based on the result of the analyzing and an indication message to indicate at least one of: a media decoded from the bitstream is inconsistent or incoherent for consumption by a user, the media decoded from the bitstream is intended for machine analysis, or the media decoded from the bitstream is suitable for watching by the user. An example of the indication message includes, but is not limited to, an indication supplemental enhancement information (SEI) message. Some examples of media include, but are not limited to, haptics, audio, video, and images. Some examples of consumption include, but are not limited to, viewing, listening, or combination thereof.

Example 2: The method of example 1, wherein analyzing the media comprises detecting one or more objects in the media and considering background to comprise areas outside the one or more objects, and encoding comprises one or more object-based methods comprising: preprocessing the media by including the one or more objects in the preprocessed media, while the background is replaced by one or more constant values or removed; preprocessing the media forming a grid, wherein a single grid cell covers an object of the one or more objects and downsampling grid rows or grid columns that do not include the object; preprocessing the background by a blurring filter or alike; and/or encoding the background with coarser quantization than the one or more objects.

Example 3: The method of example 1 further comprising: downsampling the media temporally.

Example 4: The method of example 1 further comprising: increasing quantization parameter of one or more highest temporal sublayers when compared to practices for media watchable by the user.

Example 5: The method of any of the previous examples, wherein the indication message comprises a machine consumption indication message.

Example 6: The method of example 2, wherein the indication message further comprises information indicative of the one or more object-based methods.

Example 7: The method of example 3, wherein the indication message further comprises: an indication that the media has been preprocessed and/or encoded so that the picture rate of the decoded output media is lower than an original picture rate.

Example 8: The method of example 4, wherein the indication message further comprises: an indication that the media has been preprocessed and/or encoded so that a picture quality is not temporally stable to an extent that the output media is not suitable for watching by the user.

Example 9: The method of example 4, wherein the indication message further comprises: information indicative of temporal sublayers that are intended for computer vision tasks.

Example 10: A method comprising: decoding from or along a bitstream an indication message indicating that a media decoded from the bitstream is inconsistent or incoherent for consumption by a user and/or the media decoded from the bitstream is intended for machine analysis; decoding or inferring that the media decoded from the bitstream is within the scope of the indication message; decoding from the indication message whether the media decoded from the bitstream within the scope is intended for machine vision tasks and/or is intended for consumption by the user; and in response to the decoding from the indication message, serving the media decoded from the bitstream within the scope to a machine task and/or displaying the media decoded from the bitstream within the scope to the user.

Example 11: The method of example 10 further comprising: decoding from the indication message that one or more temporal sublayers of the media decoded from the bitstream within the scope are intended for machine vision tasks; and serving decoded frames associated to one or more temporal sublayers of the media decoded from the bitstream within the scope to a machine task.

Example 12: The method of example 10 further comprising: decoding from the machine consumption indication message that one or more temporal sublayers of the media decoded from the bitstream is within the scope are suitable for watching by the user; and serving the decoded frames associated to one or more temporal sublayers of the media decoded from the bitstream within the scope to displaying.

Example 13: An apparatus comprising: at least one processor; and at least one memory storing instructions that, when executed by the at least one processor, cause the apparatus at least to perform: analyzing a media; and encoding in or along a bitstream the media based on the result of the analyzing and an indication message to indicate at least one of: a media decoded from the bitstream is inconsistent or incoherent for consumption by a user, the media decoded from the bitstream is intended for machine analysis, or the media decoded from the bitstream is suitable for watching by the user.

Example 14: The apparatus of example 13, wherein to perform analyzing the media, the apparatus is further caused to perform detecting one or more objects in the media and considering background to comprise areas outside the one or more objects, and wherein to perform encoding, the apparatus is further caused to perform one or more object-based methods comprising: preprocessing the media by including the one or more objects in the preprocessed media, while the background is replaced by one or more constant values or removed; preprocessing the media forming a grid, wherein a single grid cell covers an object of the one or more objects and downsampling grid rows or grid columns that do not include the object; preprocessing the background by a blurring filter or alike; and/or encoding the background with coarser quantization than the one or more objects.

Example 15: The apparatus of example 13, wherein the apparatus is further caused to perform: downsampling the media temporally.

Example 16: The apparatus of example 13, wherein the apparatus is further caused to perform: increasing quantization parameter of one or more highest temporal sublayers when compared to practices for media watchable by the user.

Example 17: The apparatus of any of the previous examples, wherein the indication message comprises a machine consumption indication message.

Example 18: The apparatus of example 14 wherein the indication message further comprises information indicative of the one or more object-based methods.

Example 19: The apparatus of example 15, wherein the indication message further comprises: an indication that the media has been preprocessed and/or encoded so that the picture rate of the decoded output media is lower than an original picture rate.

Example 20: The apparatus of example 16, wherein the indication message further comprises: an indication that the media has been preprocessed and/or encoded so that a picture quality is not temporally stable to an extent that the output media is not suitable for watching by the user.

Example 21: The apparatus of example 16, wherein the indication message further comprises: information indicative of temporal sublayers that are intended for computer vision tasks.

Example 22: An apparatus comprising: at least one processor; and at least one memory storing instructions that, when executed by the at least one processor, cause the apparatus at least to perform: decoding from or along a bitstream an indication message indicating that a media decoded from the bitstream is inconsistent or incoherent for consumption by a user and/or the media decoded from the bitstream is intended for machine analysis; decoding or inferring that the media decoded from the bitstream is within the scope of the indication message; decoding from the indication message whether the media decoded from the bitstream within the scope is intended for machine vision tasks and/or is intended for consumption by the user; and in response to the decoding from the indication message, serving the media decoded from the bitstream within the scope to a machine task and/or displaying the media decoded from the bitstream within the scope to the user.

Example 23: The apparatus of example 22, wherein the apparatus is further caused to perform: decoding from the indication message that one or more temporal sublayers of the media decoded from the bitstream is within the scope are intended for machine vision tasks; and serving decoded frames associated to one or more temporal sublayers of the media decoded from the bitstream within the scope to a machine task.

Example 24: The apparatus of example 22, wherein the apparatus is further caused to perform: decoding from the machine consumption indication message that one or more temporal sublayers of the media decoded from the bitstream within the scope are suitable for watching by the user; and serving the decoded frames associated to one or more temporal sublayers of the media decoded from the bitstream within the scope to displaying.

Example 25: A computer-readable medium encoded with instructions that, when executed by an apparatus, causes the apparatus to perform a method according to any of the examples 1 to 9 or 10 to 12.

Example 26: The computer-readable medium of example 25, wherein the computer-readable medium comprises a non-transitory computer-readable medium.

Example 27: An apparatus comprising means for performing the methods according to any of the examples 1 to 9 and/or examples 10 to 12.

### BRIEF DESCRIPTION OF THE DRAWINGS

The foregoing aspects and other features are explained in the following description, taken in connection with the accompanying drawings, wherein:

FIG. 1 shows schematically an electronic device employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 shows schematically a block diagram of an encoder on a general level.

FIG. 5 is a block diagram showing an interface between an encoder and a decoder in accordance with the examples described herein.

FIG. 6 illustrates a system configured to support streaming of media data from a source to a client device.

FIG. 7 is a block diagram of an apparatus that may be specifically configured in accordance with an example embodiment.

FIG. 8 illustrates a pipeline of video coding for machines (VCM.

FIG. 9 illustrates an encoder-side block diagram.

FIG. 10 illustrates an embodiment for encoding.

FIG. 11 illustrates an embodiment for decoding.

FIG. 12 is an example apparatus, which may be implemented in hardware, and is caused to provide or receive indication of machine consumption properties in media bitstreams, based on the examples described herein.

FIG. 13 is an example method to implement the embodiments described herein, in accordance with an embodiment.

FIG. 14 is an example method to implement the embodiments described herein, in accordance with another embodiment.

FIG. 15 is an example method to implement the embodiments described herein, in accordance with yet another embodiment.

FIG. 16 is a block diagram of one possible and non-limiting system in which the example embodiments may be practiced.

### DETAILED DESCRIPTION OF EXAMPLE EMBODIMENTS

The following acronyms and abbreviations that may be found in the specification and/or the drawing figures are defined as follows:
3GP 3GPP file format
3GPP 3rd Generation Partnership Project
3GPP TS 3GPP technical specification
4CC four character code
4G fourth generation of broadband cellular network technology
5G fifth generation cellular network technology
5GC 5G core network
ACC accuracy
AGT approximated ground truth data
AI artificial intelligence
AIoT AI-enabled IoT
ALF adaptive loop filtering
a.k.a. also known as
AMF access and mobility management function
APS adaptation parameter set
AVC advanced video coding
bpp bits-per-pixel
CABAC context-adaptive binary arithmetic coding
CDMA code-division multiple access
CE core experiment
ctu coding tree unit
CU central unit
CVC conventional video codec
DASH dynamic adaptive streaming over HTTP
DCT discrete cosine transform
DCI decoding compatibility information
DSP digital signal processor
DSNN decoder-side NN
DU distributed unit
eNB (or eNodeB) evolved Node B (for example, an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, for example, the LTE radio access technology
FDMA frequency division multiple access
f(n) fixed-pattern bit string using n bits written (from left to right) with the left bit first.
F1 or F1-C interface between CU and DU control interface
FDC finetuning-driving content
gNB (or gNodeB) base station for 5G/NR, for example, a node providing NR user plane and control plane protocol terminations towards the UE, and connected via the NG interface to the 5GC
GSM Global System for Mobile communications
GT ground truth
H.222.0 MPEG-2 Systems is formally known as ISO/IEC 13818-1 and as ITU-T Rec. H.222.0
H.26x family of video coding standards in the domain of the ITU-T
HLS high level syntax
HQ high-quality
IBC intra block copy
ID identifier
IEC International Electrotechnical Commission
IEEE Institute of Electrical and Electronics Engineers
I/F interface
IMD integrated messaging device
IMS instant messaging service
IoT internet of things
IP internet protocol
IRAP intra random access point
ISO International Organization for Standardization
ISOBMFF ISO base media file format
ITU International Telecommunication Union
ITU-T ITU Telecommunication Standardization Sector
JPEG joint photographic experts group
LCVC lossy conventional video codec
LIC learned image compression
LL-CVC lossless conventional video codec
LMCS luma mapping with chroma scaling
LPNN loss proxy NN
LQ low-quality
LTE long-term evolution
LZMA Lempel-Ziv-Markov chain compression
LZMA2 simple container format that can include both uncompressed data and LZMA data
LZO Lempel-Ziv-Oberhumer compression
LZW Lempel-Ziv-Welch compression
MAC medium access control
mdat MediaDataBox
MME mobility management entity
MMS multimedia messaging service
moov MovieBox
MP4 file format for MPEG-4 Part 14 files
MPEG moving picture experts group
MPEG-2 H.222/H.262 as defined by the ITU
MPEG-4 audio and video coding standard for ISO/IEC 14496
MSB most significant bit
MSE Mean-squared error
NAL network abstraction layer
NDU NN compressed data unit
ng or NG new generation
ng-eNB or NG-eNB new generation eNB
NN neural network
NNEF neural network exchange format
NNR neural network representation
NR new radio (5G radio)
N/W or NW network
OBU open bitstream unit
ONNX Open Neural Network eXchange
PB protocol buffers
PC personal computer
PDA personal digital assistant
PDCP packet data convergence protocol
PHY physical layer
PID packet identifier
PLC power line communication
PNG portable network graphics
PSNR peak signal-to-noise ratio
RA Random access
RAM random access memory
RAN radio access network
RBSP raw byte sequence payload
RD loss rate distortion loss
RFC request for comments
RFID radio frequency identification
RLC radio link control
RRC radio resource control
RRH remote radio head
RU radio unit
Rx receiver
SDAP service data adaptation protocol
SEI supplemental enhancement information
SGD Stochastic Gradient Descent
SGW serving gateway
SMF session management function
SMS short messaging service
SPS sequence parameter set
st(v) null-terminated string encoded as UTF-8 characters as specified in ISO/IEC 10646
SVC scalable video coding
S1 interface between eNodeBs and the EPC
TCP-IP transmission control protocol-internet protocol
TDMA time divisional multiple access
trak TrackBox
TS transport stream
TUC technology under consideration
TV television
Tx transmitter
UE user equipment
ue(v) unsigned integer Exp-Golomb-coded syntax element with the left bit first
UICC Universal Integrated Circuit Card
UMTS Universal Mobile Telecommunications System
u(n) unsigned integer using n bits
UPF user plane function
URI uniform resource identifier
URL uniform resource locator
UTF-8 8-bit Unicode Transformation Format
VPS video parameter set
WLAN wireless local area network
X2 interconnecting interface between two eNodeBs in LTE network
Xn interface between two NG-RAN nodes

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms ‘data,’ ‘content,’ ‘information,’ and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a ‘computer-readable storage medium,’ which refers to a non-transitory physical storage medium (e.g., volatile or non-volatile memory device), can be differentiated from a ‘computer-readable transmission medium,’ which refers to an electromagnetic signal.

A method, apparatus and computer program product are provided in accordance with example embodiments for providing and/or receiving indication of machine consumption properties in media bitstreams.

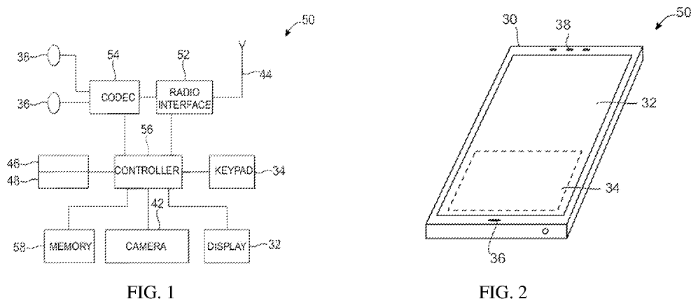

In an example, the following describes in detail suitable apparatus and possible mechanisms for providing indication of machine consumption properties in video bitstreams. In this regard reference is first made to FIG. 1 and FIG. 2, where FIG. 1 shows an example block diagram of an apparatus 50. The apparatus may be an Internet of Things (IoT) apparatus configured to perform various functions, for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 will be explained next.

The apparatus 50 may for example be a mobile terminal or user equipment of a wireless communication system, a sensor device, a tag, or a lower power device. However, it would be appreciated that embodiments of the examples described herein may be implemented within any electronic device or apparatus which may process data by neural networks.

The apparatus 50 may comprise a housing 30 for incorporating and protecting the device. The apparatus 50 may further comprise a display 32, for example, in the form of a liquid crystal display, light emitting diode display, organic light emitting diode display, and the like. In other embodiments of the examples described herein the display may be any suitable display technology suitable to display media or multimedia content, for example, an image or a video. The apparatus 50 may further comprise a keypad 34. In other embodiments of the examples described herein any suitable data or user interface mechanism may be employed. For example, the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device which in embodiments of the examples described herein may be any one of: an earpiece 38, speaker, or an analogue audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera 42 capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56, a processor or a processor circuitry for controlling the apparatus 50. The controller 56 may be connected to a memory 58 which in embodiments of the examples described herein may store both data in the form of an image, audio data and video data, and/or may also store instructions for implementation on the controller 56. The controller 56 may further be connected to codec circuitry 54 suitable for carrying out coding and/or decoding of audio, image and/or video data or assisting in coding and/or decoding carried out by the controller.

The apparatus 50 may further comprise a card reader 48 and a smart card 46, for example, a UICC and UICC reader for providing user information and being suitable for providing authentication information for authentication and authorization of the user at a network.

The apparatus 50 may comprise radio interface circuitry 52 connected to the controller and suitable for generating wireless communication signals, for example, for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The apparatus 50 may comprise a camera 42 capable of recording or detecting individual frames which are then passed to the codec circuitry 54 or the controller for processing. The apparatus may receive the video image data for processing from another device prior to transmission and/or storage. The apparatus 50 may also receive either wirelessly or by a wired connection the image for coding/decoding. The structural elements of apparatus 50 described above represent examples of means for performing a corresponding function.

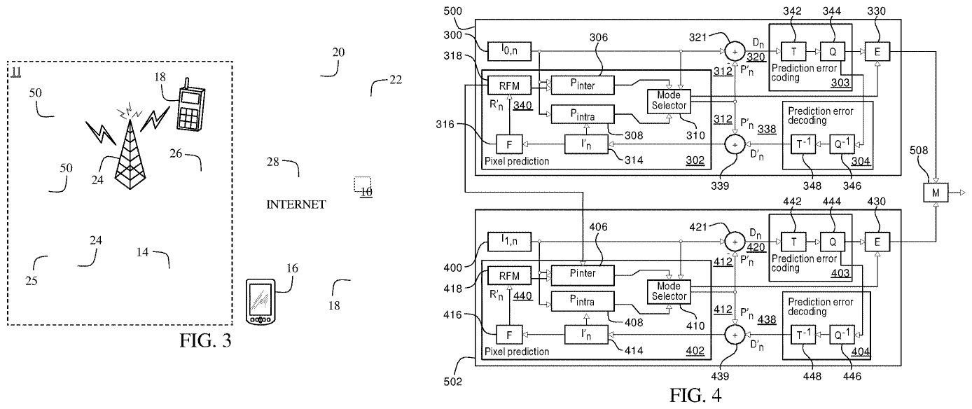

With respect to FIG. 3, an example of a system within which embodiments of the examples described herein can be utilized is shown. The system 10 comprises multiple communication devices which can communicate through one or more networks. The system 10 may comprise any combination of wired or wireless networks including, but not limited to, a wireless cellular telephone network (such as a GSM, UMTS, CDMA, LTE, 4G, 5G network, and the like), a wireless local area network (WLAN) such as defined by any of the IEEE 802.x standards, a Bluetooth® personal area network, an Ethernet local area network, a token ring local area network, a wide area network, and the Internet.

The system 10 may include both wired and wireless communication devices and/or apparatus 50 suitable for implementing embodiments of the examples described herein.

For example, the system shown in FIG. 3 shows a mobile telephone network 11 and a representation of the Internet 28. Connectivity to the Internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; for example, a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the Internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in internet of things (IoT) devices. The IoT may be defined, for example, as an interconnection of uniquely identifiable embedded computing devices within the existing Internet infrastructure. The convergence of various technologies has and may enable many fields of embedded systems, such as wireless sensor networks, control systems, home/building automation, and the like, to be included in the IoT. In order to utilize the IoT devices are provided with an IP address as a unique identifier. The IoT devices may be provided with a radio transmitter, such as WLAN or Bluetooth transmitter or a RFID tag. Alternatively, the IoT devices may have access to an IP-based network via a wired network, such as an Ethernet-based network or a power-line connection (PLC).

The devices/systems described in FIGS. 1 to 3 enable encoding, decoding, and/or transportation of, for example, a neural network representation and/or a media bitstream.

An MPEG-2 transport stream (TS), specified in ISO/IEC 13818-1 or equivalently in ITU-T Recommendation H.222.0, is a format for carrying audio, video, and other media as well as program metadata or other metadata, in a multiplexed stream. A packet identifier (PID) is used to identify an elementary stream (a.k.a. packetized elementary stream) within the TS. Hence, a logical channel within an MPEG-2 TS may be considered to correspond to a specific PID value.

Available media file format standards include ISO base media file format (ISO/IEC 14496-12, which may be abbreviated ISOBMFF) and file format for NAL unit structured video (ISO/IEC 14496-15), which derives from the ISOBMFF.

The Advanced Video Coding standard (which may be abbreviated H.264, AVC or H.264/AVC) was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organization for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

The High Efficiency Video Coding standard (which may be abbreviated H.265, HEVC or H.265/HEVC) was developed by the Joint Collaborative Team-Video Coding (JCT-VC) of VCEG and MPEG. The standard is published by both parent standardization organizations, and it is referred to as ITU-T Recommendation H.265 and ISO/IEC International Standard 23008-2, also known as MPEG-H Part 2 High Efficiency Video Coding (HEVC). Extensions to H.265/HEVC include scalable, multiview, three-dimensional, and fidelity range extensions, which may be referred to as SHVC, MV-HEVC, 3D-HEVC, and REXT, respectively. The references in this description to H.265/HEVC, SHVC, MV-HEVC, 3D-HEVC and REXT that have been made for the purpose of understanding definitions, structures or concepts of these standard specifications are to be understood to be references to the latest versions of these standards that were available before the date of this application, unless otherwise indicated.

Versatile Video Coding (which may be abbreviated VVC, H.266, or H.266/VVC) is a video compression standard developed as the successor to HEVC. VVC is specified in ITU-T Recommendation H.266 and equivalently in ISO/IEC 23090-3, which is also referred to as MPEG-I Part 3.

A specification of the AV1 bitstream format and decoding process were developed by the Alliance of Open Media (AOM). The AV1 specification was published in 2018. AOM is reportedly working on the AV2 specification.

ITU-T Recommendation H.274, which is equivalent to ISO/IEC 23002-7, may be called “versatile supplemental enhancement information messages for coded video bitstreams” and be referred to as “versatile supplemental enhancement information” or VSEI. The VSEI standard specifies the syntax and semantics of video usability information (VUI) parameters and supplemental enhancement information (SEI) messages. The VUI parameters and SEI messages defined in the VSEI standard are designed to be conveyed within coded video bitstreams in a manner specified in a video coding specification or to be conveyed by other means determined by the specifications for systems that make use of such coded video bitstreams. The VSEI standard is intended for use with VVC coded video bitstreams, although it is drafted in a manner intended to be sufficiently generic that it can also be used with other types of coded video bitstreams. VUI parameters and SEI messages may, for example, assist in processes related to decoding, display or other purposes.

Video codec consists of an encoder that transforms the input video into a compressed representation suited for storage/transmission and a decoder that can decompress the compressed video representation back into a viewable form, or into a form that is suitable as an input to one or more algorithms for analysis or processing. A video encoder and/or a video decoder may also be separate from each other, for example, need not form a codec. Typically, encoder discards some information in the original video sequence in order to represent the video in a more compact form (e.g., at lower bitrate).

Typical hybrid video encoders, for example, many encoder implementations of H.264, encode the video information in two phases. Firstly, pixel values in a certain picture area (or ‘block’) are predicted, for example, by motion compensation means (finding and indicating an area in one of the previously coded video frames that corresponds closely to the block being coded) or by spatial means (using the pixel values around the block to be coded in a specified manner). Secondly the prediction error, for example, the difference between the predicted block of pixels and the original block of pixels, is coded. This is typically done by transforming the difference in pixel values using a specified transform (for example, Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

In temporal prediction, the sources of prediction are previously decoded pictures (a.k.a. reference pictures). In intra block copy (IBC; a.k.a. intra-block-copy prediction and current picture referencing), prediction is applied similarly to temporal prediction, but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter prediction may refer to temporal prediction only, while in other cases inter prediction may refer collectively to temporal prediction and any of intra block copy, inter-layer prediction, and inter-view prediction provided that they are performed with the same or similar process than temporal prediction. Inter prediction or temporal prediction may sometimes be referred to as motion compensation or motion-compensated prediction.

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in spatial or transform domain, for example, either sample values or transform coefficients can be predicted. Intra prediction is typically exploited in intra-coding, where no inter prediction is applied.

One outcome of the coding procedure is a set of coding parameters, such as motion vectors and quantized transform coefficients. Many parameters can be entropy-coded more efficiently when they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

FIG. 4 shows a block diagram of a general structure of a video encoder. FIG. 4 presents an encoder for two layers, but it would be appreciated that presented encoder could be similarly extended to encode more than two layers. FIG. 4 illustrates a video encoder comprising a first encoder section 500 for a base layer and a second encoder section 502 for an enhancement layer. Each of the first encoder section 500 and the second encoder section 502 may comprise similar elements for encoding incoming pictures. The encoder sections 500, 502 may comprise a pixel predictor 302, 402, prediction error encoder 303, 403 and prediction error decoder 304, 404. FIG. 4 also shows an embodiment of the pixel predictor 302, 402 as comprising an inter-predictor 306, 406, an intra-predictor 308, 408, a mode selector 310, 410, a filter 316, 416, and a reference frame memory 318, 418. The pixel predictor 302 of the first encoder section 500 receives base layer picture(s)/image(s) 300 of a video stream to be encoded at both the inter-predictor 306 (which determines the difference between the image and a motion compensated reference frame) and the intra-predictor 308 (which determines a prediction for an image block based only on the already processed parts of current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the base layer image(s) 300. Correspondingly, the pixel predictor 402 of the second encoder section 502 receives enhancement layer picture(s)/images(s) 400 of a video stream to be encoded at both the inter-predictor 406 (which determines the difference between the image and a motion compensated reference frame) and the intra-predictor 408 (which determines a prediction for an image block based only on the already processed parts of current frame or picture). The output of both the inter-predictor and the intra-predictor are passed to the mode selector 410. The intra-predictor 408 may have more than one intra-prediction modes. Hence, each mode may perform the intra-prediction and provide the predicted signal to the mode selector 410. The mode selector 410 also receives a copy of the enhancement layer pictures 400.

Depending on which encoding mode is selected to encode the current block, the output of the inter-predictor 306, 406 or the output of one of the optional intra-predictor modes or the output of a surface encoder within the mode selector is passed to the output of the mode selector 310, 410. The output of the mode selector 310, 410 is passed to a first summing device 321, 421. The first summing device may subtract the output of the pixel predictor 302, 402 from the base layer image(s) 300/enhancement layer image(s) 400 to produce a first prediction error signal 320, 420 which is input to the prediction error encoder 303, 403.

The pixel predictor 302, 402 further receives from a preliminary reconstructor 339, 439 the combination of the prediction representation of the image block 312, 412 and the output 338, 438 of the prediction error decoder 304, 404. The preliminary reconstructed image 314, 414 may be passed to the intra-predictor 308, 408 and to the filter 316, 416. The filter 316, 416 receiving the preliminary representation may filter the preliminary representation and output a final reconstructed image 340, 440 which may be saved in the reference frame memory 318, 418. The reference frame memory 318 may be connected to the inter-predictor 306 to be used as the reference image against which a future base layer image 300 is compared in inter-prediction operations. Subject to the base layer being selected and indicated to be source for inter-layer sample prediction and/or inter-layer motion information prediction of the enhancement layer according to some embodiments, the reference frame memory 318 may also be connected to the inter-predictor 406 to be used as the reference image against which a future enhancement layer image(s) 400 is compared in inter-prediction operations. Moreover, the reference frame memory 418 may be connected to the inter-predictor 406 to be used as the reference image against which the future enhancement layer image(s) 400 is compared in inter-prediction operations.

Filtering parameters from the filter 316 of the first encoder section 500 may be provided to the second encoder section 502 subject to the base layer being selected and indicated to be source for predicting the filtering parameters of the enhancement layer according to some embodiments.

The prediction error encoder 303, 403 comprises a transform unit 342, 442 and a quantizer 344, 444. The transform unit 342, 442 transforms the first prediction error signal 320, 420 to a transform domain. The transform is, for example, the DCT transform. The quantizer 344, 444 quantizes the transform domain signal, for example, the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder may be considered to comprise a dequantizer 346, 446, which dequantizes the quantized coefficient values, for example, DCT coefficients, to reconstruct the transform signal and an inverse transformation unit 348, 448, which performs the inverse transformation to the reconstructed transform signal wherein the output of the inverse transformation unit 348, 448 contains reconstructed block(s). The prediction error decoder may also comprise a block filter which may filter the reconstructed block(s) according to further decoded information and filter parameters.

The entropy encoder 330, 430 receives the output of the prediction error encoder 303, 403 and may perform a suitable entropy encoding/variable length encoding on the signal to provide a compressed signal. The outputs of the entropy encoders 330, 430 may be inserted into a bitstream, for example, by a multiplexer 508.

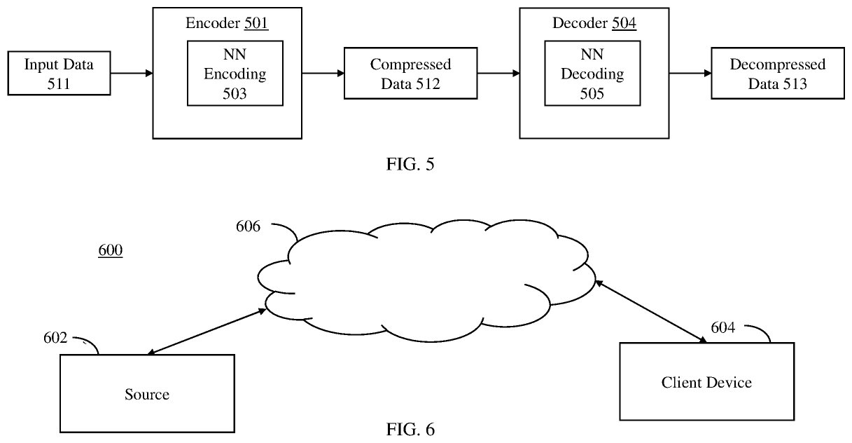

FIG. 5 is a block diagram showing the interface between an encoder 501 implementing neural network based encoding 503, and a decoder 504 implementing neural network based decoding 505 in accordance with the examples described herein. The encoder 501 may embody a device, a software method or a hardware circuit. The encoder 501 has the goal of compressing an input data 511 (for example, an input video) to a compressed data 512 (for example, a bitstream) such that the bitrate measuring the size of compressed data 512 is minimized, and the accuracy of an analysis or processing algorithm is maximized. To this end, the encoder 501 uses an encoder or compression algorithm, for example to perform neural network based encoding 503, e.g., encoding the input data by using one or more neural networks.

The general analysis or processing algorithm may be part of the decoder 504. The decoder 504 uses a decoder or decompression algorithm, for example, to perform the neural network based decoding 505 (e.g., decoding by using one or more neural networks) to decode the compressed data 512 (for example, compressed video) which was encoded by the encoder 501. The decoder 504 produces decompressed data 513 (for example, reconstructed data).

The encoder 501 and decoder 504 may be entities implementing an abstraction, may be separate entities or the same entities, or may be part of the same physical device.

The analysis/processing algorithm may be any algorithm, traditional or learned from data. In the case of an algorithm which is learned from data, in some embodiments it is assumed that this algorithm can be modified or updated, for example, by using optimization via gradient descent. An example of the learned algorithm is a neural network.

An out-of-band transmission, signaling, or storage may refer to the capability of transmitting, signaling, or storing information in a manner that associates the information with a video bitstream. The out-of-band transmission may use a more reliable transmission mechanism compared to the protocols used for carrying coded video data, such as slices. The out-of-band transmission, signaling or storage can additionally or alternatively be used e.g. for ease of access or session negotiation. For example, a sample entry of a track in a file conforming to the ISO Base Media File Format may comprise parameter sets, while the coded data in the bitstream is stored elsewhere in the file or in another file. Another example of out-of-band transmission, signaling, or storage comprises including information, such as NN and/or NN updates in a file format track that is separate from track(s) containing coded video data.

The phrase along the bitstream (e.g. indicating along the bitstream) or along a coded unit of a bitstream (e.g. indicating along a coded tile) may be used in claims and described embodiments to refer to transmission, signaling, or storage in a manner that the ‘out-of-band’ data is associated with, but not included within, the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream. In another example, the phrase along the bitstream may be used when the bitstream is made available as a stream over a communication protocol and a media description, such as a streaming manifest, is provided to describe the stream.

A bitstream may be defined as a sequence of bits or a sequence of syntax structures. A bitstream format may constrain the order of syntax structures in the bitstream.

A syntax element may be defined as an element of data represented in a bitstream. A syntax structure may be defined as zero or more syntax elements present together in a bitstream in a specified order.

Syntax structures may be specified, for example, using arithmetic, logical, relational, bit-wise, and assignment operators similar to those available in many programming languages. For example, & may indicate a bit-wise AND operation. Furthermore, syntax structures may be specified with reference to mathematical functions

Syntax structures and semantics may use the values of variables derived from the values of syntax elements. Naming conventions may be defined for variables. For example, variables may be named by a mixture of lower case and upper case letter and without any underscore characters. Variables starting with an upper case letter may be derived for the decoding of the current syntax structure and all depending syntax structures. Variables starting with an upper case letter may, in some cases, be used in the decoding process for later syntax structures without mentioning the originating syntax structure of the variable. Variables starting with a lower case letter may only be used in relation to the syntax structure or function they have been defined for.

An elementary unit for the output of a video encoder and the input of a video decoder, respectively, may be a network abstraction layer (NAL) unit. For transport over packet-oriented networks or storage into structured files, NAL units may be encapsulated into packets or similar structures. A bytestream format encapsulating NAL units may be used for transmission or storage environments that do not provide framing structures. The bytestream format may separate NAL units from each other by attaching a start code in front of each NAL unit. To avoid false detection of NAL unit boundaries, encoders may run a byte-oriented start code emulation prevention algorithm, which may add an emulation prevention byte to the NAL unit payload if a start code would have occurred otherwise. In order to enable straightforward gateway operation between packet and stream-oriented systems, start code emulation prevention may be performed regardless of whether the bytestream format is in use or not. A NAL unit may be defined as a syntax structure containing an indication of the type of data to follow and bytes containing that data in the form of a raw byte sequence payload interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

A bitstream may be defined to logically include a syntax structure, such as a NAL unit, when the syntax structure is transmitted along the bitstream but may be included in the bitstream according to the bitstream format. A bitstream may be defined to natively comprise a syntax structure, when the bitstream includes the syntax structure.

In some coding formats or standards, a bitstream may be in the form of a network abstraction layer (NAL) unit stream or a byte stream, that forms the representation of coded pictures and associated data forming one or more coded video sequences.

In some coding formats or standards, the end of a bitstream may be indicated by a specific NAL unit, which may be referred to as the end of bitstream (EOB) NAL unit and which is the last NAL unit of the bitstream.

In some formats or standards, a first bitstream may be followed by a second bitstream in the same logical channel, such as in the same file or in the same connection of a communication protocol. An elementary stream (in the context of video coding) may be defined as a sequence of one or more bitstreams.

In some coding formats, such as AV1, a bitstream may comprise a sequence of open bitstream units (OBUs). An OBU comprises a header and a payload, wherein the header identifies a type of the OBU. Furthermore, the header may comprise a size of the payload in bytes.

In some coding standards, NAL units include a header and payload. The NAL unit header indicates the type of the NAL unit. In some coding standards, the NAL unit header indicates a scalability layer identifier (e.g. called nuh_layer_id in H.265/HEVC and H.266/VVC), which could be used e.g. for indicating spatial or quality layers, views of a multiview video, or auxiliary layers (such as depth maps or alpha planes). In some coding standards, the NAL unit header includes a temporal sublayer identifier, which may be used for indicating temporal subsets of the bitstream, such as a 30-frames-per-second subset of a 60-frames-per-second bitstream.

Bitstreams or coded video sequences can be encoded to be temporally scalable as follows. Each picture may be assigned to a particular temporal sub-layer. A temporal sub-layer may be equivalently called a sub-layer, temporal sublayer, sublayer, or temporal level. Temporal sub-layers may be enumerated e.g., from 0 upwards. The lowest temporal sub-layer, sub-layer 0, may be decoded independently. Pictures at temporal sub-layer 1 may be predicted from reconstructed pictures at temporal sub-layers 0 and 1. Pictures at temporal sub-layer 2 may be predicted from reconstructed pictures at temporal sub-layers 0, 1, and 2, and so on. In other words, a picture at temporal sub-layer N does not use any picture at temporal sub-layer greater than N as a reference for inter prediction. The bitstream created by excluding all pictures greater than or equal to a selected sub-layer value and including pictures remains conforming.

Each picture of a temporally scalable bitstream may be assigned with a temporal identifier (also known as temporal layer identifier, temporal sublayer identifier, or temporal layer ID), which may be, for example, assigned to a variable TemporalId. The temporal identifier may, for example, be indicated in a NAL unit header or in an OBU extension header. TemporalId equal to 0 corresponds to the lowest temporal level. The bitstream created by excluding all coded pictures having a TemporalId greater than or equal to a selected value and including all other coded pictures remains conforming. Consequently, a picture having TemporalId equal to tid_value does not use any picture having a TemporalId greater than tid_value as a prediction reference.

NAL units may be categorized into Video Coding Layer (VCL) NAL units and non-VCL NAL units. VCL NAL units are typically coded slice NAL units.

A non-VCL NAL unit may be, for example, one of the following types: a video parameter set (VPS), a sequence parameter set (SPS), a picture parameter set (PPS), an adaptation parameter set (APS), a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

Some coding formats specify parameter sets that may carry parameter values needed for the decoding or reconstruction of decoded pictures. A parameter may be defined as a syntax element of a parameter set. A parameter set may be defined as a syntax structure that contains parameters and that can be referred to from or activated by another syntax structure, for example, using an identifier.

Some types of parameter sets are briefly described in the following, but it needs to be understood, that other types of parameter sets may exist and that embodiments may be applied, but are not limited to, the described types of parameter sets.

Parameters that remain unchanged through a coded video sequence may be included in a sequence parameter set. Alternatively, an SPS may be limited to apply to a layer that references the SPS, e.g. an SPS may remain valid for a coded layer video sequence. In addition to the parameters that may be needed by the decoding process, the sequence parameter set may optionally contain video usability information (VUI), which includes parameters that may be important for buffering, picture output timing, rendering, and resource reservation.

A picture parameter set contains such parameters that are likely to be unchanged in several coded pictures. A picture parameter set may include parameters that can be referred to by the VCL NAL units of one or more coded pictures.

A video parameter set (VPS) may be defined as a syntax structure containing syntax elements that apply to zero or more entire coded video sequences and may contain parameters applying to multiple layers. The VPS may provide information about the dependency relationships of the layers in a bitstream, as well as many other information that are applicable to all slices across all layers in the entire coded video sequence.

A video parameter set RBSP may include parameters that can be referred to by one or more sequence parameter set RBSPs.

The relationship and hierarchy between a video parameter set (VPS), a sequence parameter set (SPS), and a picture parameter set (PPS) may be described as follows. A VPS resides one level above an SPS in the parameter set hierarchy and in the context of scalability. The VPS may include parameters that are common for all slices across all layers in the entire coded video sequence. The SPS includes the parameters that are common for all slices in a particular layer in the entire coded video sequence, and may be shared by multiple layers. The PPS includes the parameters that are common for all slices in a particular picture and are likely to be shared by all slices in multiple pictures.

An adaptation parameter set (APS) may be specified in some coding formats, such as H.266/VVC. An APS may be applied to one or more image segments, such as slices. In H.266/VVC, an APS may be defined as a syntax structure containing syntax elements that apply to zero or more slices as determined by zero or more syntax elements found in slice headers or in a picture header. An APS may comprise a type (aps_params_type in H.266/VVC) and an identifier (aps_adaptation_parameter_set_id in H.266/VVC). The combination of an APS type and an APS identifier may be used to identify a particular APS. H.266/VVC comprises three APS types: an adaptive loop filtering (ALF), a luma mapping with chroma scaling (LMCS), and a scaling list APS types. The ALF APS(s) are referenced from a slice header (thus, the referenced ALF APSs can change slice by slice), and the LMCS and scaling list APS(s) are referenced from a picture header (thus, the referenced LMCS and scaling list APSs can change picture by picture). In H.266/VVC, the APS RBSP has the following syntax:

| | Descriptor |
|---|---|
| adaptation_parameter_set_rbsp( ) { | |
| aps_params_type | u(3) |
| aps_adaptation_parameter_set_id | u(5) |
| aps_chroma_present_flag | u(1) |
| if( aps_params_type = = ALF_APS ) | |
| alf_data( ) | |
| else if( aps_params_type = = LMCS_APS ) | |
| lmcs_data( ) | |
| else if( aps_params_type = = SCALING_APS ) | |
| scaling_list_data( ) | |
| aps_extension_flag | u(1) |
| if( aps_extension_flag ) | |
| while( more_rbsp_data( ) ) | |
| aps_extension_data_flag | u(1) |
| rbsp_trailing_bits( ) | |
| } | |

Video coding specifications may enable the use of supplemental enhancement information (SEI) messages or alike. Some video coding specifications include SEI NAL units, and some video coding specifications contain both prefix SEI NAL units and suffix SEI NAL units. A prefix SEI NAL unit can start a picture unit or alike; and a suffix SEI NAL unit can end a picture unit or alike. Hereafter, an SEI NAL unit may equivalently refer to a prefix SEI NAL unit or a suffix SEI NAL unit. An SEI NAL unit includes one or more SEI messages, which are not required for the decoding of output pictures but may assist in related processes, such as picture output timing, post-processing of decoded pictures, rendering, error detection, error concealment, and resource reservation.

Several SEI messages are specified in H.264/AVC, H.265/HEVC, H.266/VVC, and H.274/VSEI standards, and the user data SEI messages enable organizations and companies to specify SEI messages for specific use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

Some video coding specifications enable metadata OBUs. A metadata OBU comprises a type field, which specifies the type of metadata.

A coded video sequence (CVS) may be defined as a sequence of coded pictures in decoding order that is independently decodable and is followed by another coded video sequence or the end of the bitstream.

A coded layer video sequence (CLVS) may be defined as a sequence of pictures and associated other data within the same scalable layer (e.g., with the same value of nuh_layer_id in VVC) that is decodable independently of other pictures in the same layer.

An identifier may be defined as a syntax element that identifies a syntax structure. A value of the identifier may for example differ in different instances of the same syntax structure, such as a parameter set. A particular instance of the syntax structure may be referenced through its identifier value. For example, a parameter set that is referenced by the (de)coding of a coded video slice may be identified by providing the identifier value of the parameter set in a header of the coded video slice.

An indicator (idc) may be defined as a syntax element whose value indicates a selection among more than two values (for which semantics have been specified). An indicator syntax element may have _idc postfix in its name.

A uniform resource identifier (URI) may be defined as a string of characters used to identify a name of a resource. Such identification enables interaction with representations of the resource over a network, using specific protocols. A URI is defined through a scheme specifying a concrete syntax and associated protocol for the URI. The uniform resource locator (URL) and the uniform resource name (URN) are forms of URI. A URL may be defined as a URI that identifies a web resource and specifies the means of acting upon or obtaining the representation of the resource, specifying both its primary access mechanism and network location. A URN may be defined as a URI that identifies a resource by name in a particular namespace. A URN may be used for identifying a resource without implying its location or how to access it.

The method and apparatus of an example embodiment may be utilized in a wide variety of systems, including systems that rely upon the compression and decompression of media data and possibly also the associated metadata. In at least an embodiment, however, the method and apparatus are configured to train or finetune a decoder-side neural network. In this regard, FIG. 6 depicts an example of such a system 600 that includes a source 602 of media data and associated metadata. The source 602 may be, in an embodiment, a server. However, the source may be embodied in other manners when desired. The source 602 is configured to stream the media data and associated metadata to a client device 604. The client device may be embodied by a media player, a multimedia system, a video system, a smart phone, a mobile telephone or other user equipment, a personal computer, a tablet computer or any other computing device configured to receive and decompress the media data and process associated metadata. In the illustrated embodiment, media data and metadata are streamed via a network 606, such as any of a wide variety of types of wireless networks and/or wireline networks. The client device is configured to receive structured information containing media, metadata and any other relevant representation of information containing the media and the metadata and to decompress the media data and process the associated metadata (e.g. for proper playback timing of decompressed media data).

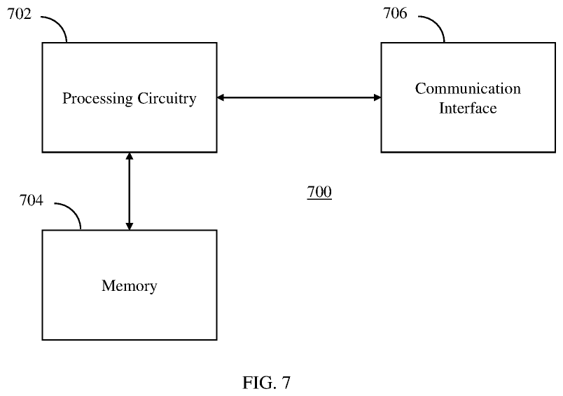

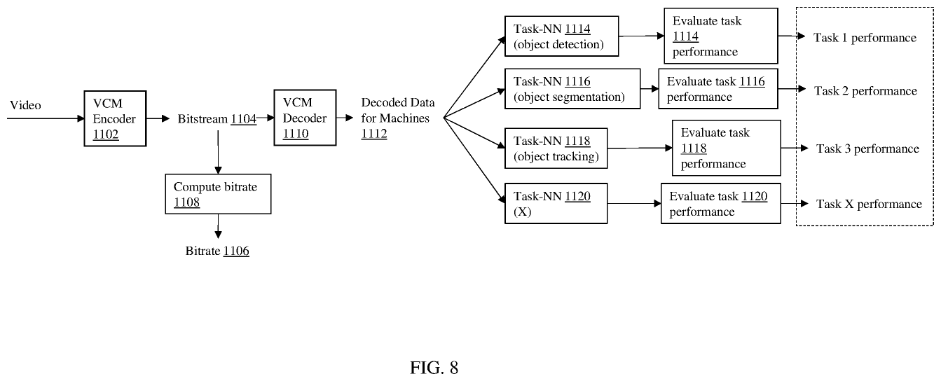

An apparatus 700 is provided in accordance with an example embodiment as shown in FIG. 7. In an embodiment, the apparatus of FIG. 7 may be embodied by the source 602, such as a file writer which, in turn, may be embodied by a server, that is configured to stream a compressed representation of the media data and associated metadata. In an alternative embodiment, the apparatus may be embodied by the client device 604, such as a file reader which may be embodied, for example, by any of the various computing devices described above. In either of these embodiments and as shown in FIG. 7, the apparatus of an example embodiment includes, is associated with or is in communication with a processing circuitry 702, one or more memory devices 704, a communication interface 706 and optionally a user interface.

The processing circuitry 702 may be in communication with the memory device 704 via a bus for passing information among components of the apparatus 700. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processing circuitry). The memory device may be configured to store information, data, content, applications, instructions, or the like for enabling the apparatus to carry out various functions in accordance with an example embodiment of the present disclosure. For example, the memory device could be configured to buffer input data for processing by the processing circuitry. Additionally or alternatively, the memory device could be configured to store instructions for execution by the processing circuitry.

The apparatus 700 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single ‘system on a chip.’ As such, in some cases, a chip or chipset may constitute means for performing one or more operations for providing the functionalities described herein.

The processing circuitry 702 may be embodied in a number of different ways. For example, the processing circuitry may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processing circuitry 702 may be configured to execute instructions stored in the memory device 704 or otherwise accessible to the processing circuitry. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of instructions, the instructions may specifically configure the processing circuitry to perform the algorithms and/or operations described herein when the instructions are executed. However, in some cases, the processing circuitry may be a processor of a specific device (e.g., an image or video processing system) configured to employ an embodiment of the present invention by further configuration of the processing circuitry by instructions for performing the algorithms and/or operations described herein. The processing circuitry may include, among other things, a clock, an arithmetic logic unit (ALU) and logic gates configured to support operation of the processing circuitry.

The communication interface 706 may be any means such as a device or circuitry embodied in either hardware or a combination of hardware and software that is configured to receive and/or transmit data, including video bitstreams. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some embodiments, the apparatus 700 may optionally include a user interface that may, in turn, be in communication with the processing circuitry 702 to provide output to a user, such as by outputting an encoded video bitstream and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processing circuitry may comprise user interface circuitry configured to control at least some functions of one or more user interface elements such as a display and, in some embodiments, a speaker, ringer, microphone and/or the like. The processing circuitry and/or user interface circuitry comprising the processing circuitry may be configured to control one or more functions of one or more user interface elements through computer program instructions (e.g., software and/or firmware) stored on a memory accessible to the processing circuitry (e.g., memory device, and/or the like).

### Fundamentals of Neural Networks

A neural network (NN) is a computation graph consisting of several layers of computation. Each layer consists of one or more units, where each unit performs a computation. A unit is connected to one or more other units, and a connection may be associated with a weight. The weight may be used for scaling the signal passing through an associated connection. Weights are learnable parameters, for example, values which can be learned from training data. There may be other learnable parameters, such as those of batch-normalization layers.

Couple of examples of architectures for neural networks are feed-forward and recurrent architectures. Feed-forward neural networks are such that there is no feedback loop, each layer takes input from one or more of the previous layers and provides its output as the input for one or more of the subsequent layers. Also, units inside a certain layer take input from units in one or more of preceding layers and provide output to one or more of following layers.

Initial layers, those close to the input data, extract semantically low-level features, for example, edges and textures in images, and intermediate and final layers extract more high-level features. After the feature extraction layers there may be one or more layers performing a certain task, for example, classification, semantic segmentation, object detection, denoising, style transfer, super-resolution, and the like. In recurrent neural networks, there is a feedback loop, so that the neural network becomes stateful, for example, it is able to memorize information or a state.

Neural networks are being utilized in an ever-increasing number of applications for many different types of devices, for example, mobile phones, chat bots, IoT devices, smart cars, voice assistants, and the like. Some of these applications include, but are not limited to, image and video analysis and processing, social media data analysis, device usage data analysis, and the like.

One of the properties of neural networks, and other machine learning tools, is that they are able to learn properties from input data, either in a supervised way or in an unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output error, also referred to as the loss. Examples of losses are mean squared error, cross-entropy, and the like. In recent deep learning techniques, training is an iterative process, where at each iteration the algorithm modifies the weights of the neural network to make a gradual improvement in the network's output, for example, gradually decrease the loss.

Training a neural network is an optimization process, but the final goal is different from the typical goal of optimization. In optimization, the only goal is to minimize a function. In machine learning, the goal of the optimization or training process is to make the model learn the properties of the data distribution from a limited training dataset. In other words, the goal is to learn to use a limited training dataset in order to learn to generalize to previously unseen data, for example, data which was not used for training the model. This is usually referred to as generalization. In practice, data is usually split into at least two sets, the training set and the validation set. The training set is used for training the network, for example, to modify its learnable parameters in order to minimize the loss. The validation set is used for checking the performance of the network on data, which was not used to minimize the loss, as an indication of the final performance of the model. In particular, the errors on the training set and on the validation set are monitored during the training process to understand the following:
when the network is learning at all—in this case, the training set error should decrease, otherwise the model is in the regime of underfitting.
when the network is learning to generalize—in this case, also the validation set error needs to decrease and be not too much higher than the training set error. For example, the validation set error should be less than 20% higher than the training set error. If the training set error is low, for example 10% of its value at the beginning of training, or with respect to a threshold that may have been determined based on an evaluation metric, but the validation set error is much higher than the training set error, or it does not decrease, or it even increases, the model is in the regime of overfitting. This means that the model has just memorized properties of the training set and performs well only on that set, but performs poorly on a set not used for training or tuning of its parameters.

Lately, neural networks have been used for compressing and de-compressing data such as images. The most widely used architecture for such task is the auto-encoder, which is a neural network consisting of two parts: a neural encoder and a neural decoder. In various embodiments, these neural encoder and neural decoder would be referred to as encoder and decoder, even though these refer to algorithms which are learned from data instead of being tuned manually. The encoder takes an image as an input and produces a code, to represent the input image, which requires less bits than the input image. This code may have been obtained by a binarization or quantization process after the encoder. The decoder takes in this code and reconstructs the image which was input to the encoder.

Such encoder and decoder are usually trained to minimize a combination of bitrate and distortion, where the distortion may be based on one or more of the following metrics: mean squared error (MSE), peak signal-to-noise ratio (PSNR), structural similarity index measure (SSIM), or the like. These distortion metrics are meant to be correlated to the human visual perception quality, so that minimizing or maximizing one or more of these distortion metrics results into improving the visual quality of the decoded image as perceived by humans.

In various embodiments, terms ‘model’, ‘neural network’, ‘neural net’ and ‘network’ may be used interchangeably, and also the weights of neural networks may be sometimes referred to as learnable parameters or as parameters.

### Fundamentals of Video/Image Coding

Video codec consists of an encoder that transforms the input video into a compressed representation suited for storage/transmission and a decoder that can decompress the compressed video representation back into a viewable form. Typically, an encoder discards some information in the original video sequence in order to represent the video in a more compact form, for example, at lower bitrate.

Typical hybrid video codecs, for example H.264, H.265, H.266 and AV1, encode the video information in two phases. Firstly, pixel values in a certain picture area (or ‘block’) are predicted, for example, by motion compensation means or circuits (by finding and indicating an area in one of the previously coded video frames that corresponds closely to the block being coded) or by spatial means or circuit (by using the pixel values around the block to be coded in a specified manner). Secondly the prediction error, e.g. the difference between the predicted block of pixels and the original block of pixels, is coded. This is typically done by transforming the difference in pixel values using a specified transform (e.g. discrete cosine transform (DCT) or a variant of it), quantizing the coefficients and entropy coding the quantized coefficients. By varying the fidelity of the quantization process, the encoder may control the balance between the accuracy of the pixel representation (e.g., picture quality) and size of the resulting coded video representation (e.g., file size or transmission bitrate).

Inter prediction, which may also be referred to as temporal prediction, motion compensation, or motion-compensated prediction, exploits temporal redundancy. In inter prediction the sources of prediction are previously decoded pictures.

Intra prediction utilizes the fact that adjacent pixels within the same picture are likely to be correlated. Intra prediction can be performed in spatial or transform domain, for example, either sample values or transform coefficients can be predicted. Intra prediction is typically exploited in intra-coding, where no inter prediction is applied.

One outcome of the coding procedure is a set of coding parameters, such as motion vectors and quantized transform coefficients. Many parameters can be entropy-coded more efficiently when they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction techniques similar to the encoder to form a predicted representation of the pixel blocks. For example, using the motion or spatial information created by the encoder and stored in the compressed representation and prediction error decoding, which is inverse operation of the prediction error coding recovering the quantized prediction error signal in spatial pixel domain. After applying prediction and prediction error decoding techniques the decoder sums up the prediction and prediction error signals, for example, pixel values to form the output video frame. The decoder and encoder can also apply additional filtering techniques to improve the quality of the output video before passing it for display and/or storing it as prediction reference for the forthcoming frames in the video sequence.

Image and video codecs may use a set of filters, which may enhance the visual quality of the predicted visual content. Filters may be applied either in-loop or out-of-loop, or both. In-loop filters (which may be also called loop filters) are used in reconstructing prediction reference that may be used for predicting forthcoming video signal. In other words, in the case of in-loop filters, the filter applied on one block in the currently encoded frame may affect the encoding of another block in the same frame and/or in another frame which is predicted from the current frame. An in-loop filter may affect the bitrate and/or the visual quality. In fact, an enhanced block may cause a smaller residual (difference between original block and predicted-and-filtered block), thus requiring less bits to be encoded. An out-of-the loop filter (which may also be called a post-processing filter or a post-filter) may be applied on a frame or part of a frame after it has been reconstructed, the filtered visual content may not be used as a source for prediction, and thus it may only impact the visual quality of the frames that are output by the decoder.

In typical video codecs the motion information is indicated with motion vectors associated with each motion compensated image block. Each of these motion vectors represents the displacement of the image block in the picture to be coded in the encoder side or decoded in the decoder side and the prediction source block in one of the previously coded or decoded pictures.

In order to represent motion vectors efficiently, the motion vectors are typically coded differentially with respect to block specific predicted motion vectors. In typical video codecs, the predicted motion vectors are created in a predefined way, for example, calculating the median of the encoded or decoded motion vectors of the adjacent blocks.

Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or or co-located blocks in temporal reference picture.

Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signaled among a list of motion field candidate list filled with motion field information of available adjacent/co-located blocks.

In typical video codecs, the prediction residual after motion compensation is first transformed with a transform kernel, for example, DCT and then coded. The reason for this is that often there still exists some correlation among the residual and transform can in many cases help reduce this correlation and provide more efficient coding.

Typical video encoders utilize Lagrangian cost functions to find optimal coding modes, for example, the desired macroblock mode and associated motion vectors. This kind of cost function uses a weighting factor λ to tie together the exact or estimated image distortion due to lossy coding methods and the exact or estimated amount of information that is required to represent the pixel values in an image area:

C=D+λR equation 1

In equation 1, C is the Lagrangian cost to be minimized, D is the image distortion, for example, mean squared error with the mode and motion vectors considered, and R is the number of bits needed to represent the required data to reconstruct the image block in the decoder including the amount of data to represent the candidate motion vectors.

### Neural-Network Post-Filter Characteristics (NNPFC) and Neural-Network Post-Filter Activation (NNPFA) SEI Messages

The neural-network post-filter characteristics (NNPFC) SEI message and the neural-network post-filter activation (NNPFA) SEI message have been described in document N0158 of ISO/IEC JTC1 SC29 WG05.

The NNPFC SEI message comprises the nnpfc_id syntax element, which includes an identifying number that may be used to identify a post-processing filter. A base post-processing filter is the filter that is included in or identified by the first NNPFC SEI message, in decoding order, that has a particular nnpfc_id value within a coded layer video sequence (CLVS). When there is a second NNPFC SEI message that has the same nnpfc_id value that defines the base post-processing filter, an update relative to the base post-processing filter is applied to obtain a post-processing filter associated with the nnpfc_id value. The update may be obtained by decoding the coded neural network bitstream in the second NNPFC SEI message. Otherwise, the post-processing filter associated with the nnpfc_id value is assigned to be the same as the base post-processing filter.

The NNPFC SEI message comprises nnpfc_mode_idc syntax element, the semantics of which may be defined as follows:
nnpfc_mode_idc equal to 0 specifies that the base post-processing filter or the update relative to the base post-processing filter associated with the nnpfc_id value is a neural network identified by the Uniform Resource Identifier (URI) nnpfc_uri with the format identified by the tag URI nnpfc_tag_uri.
nnpfc_mode_idc equal to 1 indicates that this SEI message includes an ISO/IEC 15938-17 bitstream that specifies the base post-processing filter or updates relative to the base post-processing filter with the same nnpfc_id value.

The NNPFC SEI message may also comprise:
Purpose of the post-processing filter, for example:
   Visual quality improvement
   Chroma upsampling from the 4:2:0 chroma format to the 4:2:2 or 4:4:4 chroma format, or from the 4:2:2 chroma format to the 4:4:4 chroma format
   Increasing the width or height of the cropped decoded output picture without changing the chroma format
   Increasing the width or height of the cropped decoded output picture and upsampling the chroma format
   Frame rate upsampling
Formatting of the input tensors that are given as input to the neural network inference
Formatting of the output tensors that are resulting from the neural network inference
Characterization of the complexity of the neural network

The NNPFA SEI message specifies the neural-network post-processing filter that may be used for post-processing filtering for the current picture, or for post-processing filtering for the current picture and one or more other pictures. The NNPFA SEI message comprises the nnpfa_target_id syntax element, which indicates that the neural-network post-processing filter with nnpfc_id equal to nnfpa_target_id may be used for post-processing filtering for the indicated persistence. The indicated persistence may be the current picture only (nnpfa_persistence_flag equal to 0), or until the end of the current coded layer video sequence (CLVS) or the next picture, in output order, in the current layer associated with a NNPFA SEI message with the same nnpfa_target_id as the current SEI message (nnpfa_persistence_flag equal to 1).

### Annotated Regions SEI Message

The annotated regions SEI message has been specified in the versatile supplemental enhancement information (VSEI) standard (ISO/IEC 23002-7 1 ITU-T H.274) as well as in HEVC (ISO/IEC 23008-2 1 ITU-T H.265). In the following, the syntax element names refer to the VSEI definition of the annotated regions SEI message.

The annotated regions SEI message carries parameters that identify annotated regions using bounding boxes representing the size and location of identified objects.

The annotated regions SEI message may comprise, but may not be limited to, one or more pieces of the following information:
ar_not_optimized_for_viewing_flag equal to 1 indicates that the decoded pictures, that the annotated regions SEI message applies to, are not optimized for user viewing, but rather are optimized for some other purpose such as algorithmic object classification performance. ar_not_optimized_for_viewing_flag equal to 0 indicates that the decoded pictures, that the annotated regions SEI message applies to, may or may not be optimized for user viewing.
ar_true_motion_flag equal to 1 indicates that the motion information in the coded pictures, that the annotated regions SEI message applies to, was selected with a goal of accurately representing object motion for objects in the annotated regions. ar_true_motion_flag equal to 0 indicates that the motion information in the coded pictures, that the annotated regions SEI message applies to, may or may not be selected with a goal of accurately representing object motion for objects in the annotated regions.
ar_occluded_object_flag equal to 1 indicates that each of the bounding boxes represents the size and location of an object or a portion of an object that may not be visible or may be only partially visible within the cropped decoded picture. ar_occluded_object_flag equal to 0 indicates that each of the bounding boxes represents the size and location of an object that is entirely visible within the cropped decoded picture.
Textual labels, which are assigned indices.
A language used in the labels.
A mapping of an object to a label index.
A bounding box of an object.
An indication if the bounding box represents the size and location of an object that is only partially visible within the cropped decoded picture.
A degree of confidence associated with an object.
   Example Indications to Indicate that Video is not Directly Suitable for Displaying

Video usability information (VUI) may be included in a sequence parameter set (SPS). VUI specified in VSEI comprises the following:
vui_non_packed_constraint_flag equal to 1 specifies that there shall not be any frame packing arrangement SEI messages present in the bitstream that apply to the CLVS. vui_non_packed_constraint_flag equal to 0 does not impose such a constraint.
vui_non_projected_constraint_flag equal to 1 specifies that there shall not be any equirectangular projection SEI messages or generalized cubemap projection SEI messages present in the bitstream that apply to the CLVS. vui_non_projected_constraint_flag equal to 0 does not impose such a constraint.

When an equirectangular projection SEI message or generalized cubemap projection SEI message applies to the CLVS, the decoded pictures represent omnidirectional pictures according to equirectangular or generalized cubemap projection, respectively, and should be remapped to produce a viewport for displaying.

When a frame packing arrangement SEI message applies to the CLVS, a cropped decoded picture contains samples of multiple distinct spatially packed constituent frames that are packed into one frame, or that the output cropped decoded pictures in output order form a temporal interleaving of alternating first and second constituent frames, using an indicated frame packing arrangement scheme. This information can be used by the decoder to appropriately rearrange the samples and process the samples of the constituent frames appropriately for display or other purposes.

The no display SEI message specified in HEVC indicates that the current picture (which contains or is associated with the SEI message) should not be displayed.

An annotated regions SEI message with ar_not_optimized_for_viewing_flag equal to 1 indicates that the decoded pictures that the annotated regions SEI message applies to are not optimized for user viewing, but rather are optimized for some other purpose such as algorithmic object classification performance.

### SEI Manifest SEI Message

An SEI manifest SEI message has been specified, for example, in the H.265/HEVC and H.266/VVC standards. An SEI manifest SEI message conveys information on SEI messages that are indicated as expected (e.g., likely) to be present or not present in a coded video sequence (CVS) or a bitstream. Such information may include the following:
The indication that certain types of SEI messages are expected (e.g., likely) to be present (although not guaranteed to be present) in the CVS.
For each type of SEI message that is indicated as expected (e.g., likely) to be present in the CVS, the degree of expressed necessity of interpretation of the SEI messages of this type, as follows:
   The degree of necessity of interpretation of an SEI message type may be indicated as “necessary”, “unnecessary”, or “undetermined”.
   An SEI message is indicated by the encoder (i.e., the content producer) as being “necessary” when the information conveyed by the SEI message is considered as necessary for interpretation by the decoder or receiving system in order to properly process the content and enable an adequate user experience; it does not mean that the bitstream is required to contain the SEI message in order to be a conforming bitstream. It is at the discretion of the encoder to determine which SEI messages are to be considered as necessary in a particular CVS.
The indication that certain types of SEI messages are expected (e.g., likely) not to be present (although not guaranteed not to be present) in the CVS.

The content of an SEI manifest SEI message may, for example, be used by transport-layer or systems-layer processing elements to determine whether the CVS is suitable for delivery to a receiving and decoding system, based on whether the receiving system can properly process the CVS to enable an adequate user experience or whether the CVS satisfies the application needs.

It may be required that an SEI NAL unit containing an SEI manifest SEI message does not contain any other SEI messages other than SEI prefix indication SEI messages. When present in an SEI NAL unit, the SEI manifest SEI message may be required to be the first SEI message in the SEI NAL unit.

### Video Coding for Machines (VCM)

Reducing the distortion in image and video compression is often intended to increase human perceptual quality, as humans are considered to be the end users, e.g., consuming or watching the decoded images or videos. Recently, with the advent of machine learning, especially deep learning, there is a rising number of machines (e.g., autonomous agents) that analyze or process data independently from humans and may even take decisions based on the analysis results without human intervention. Examples of such analysis are object detection, scene classification, semantic segmentation, video event detection, anomaly detection, pedestrian tracking, and the like. Example use cases and applications are self-driving cars, video surveillance cameras and public safety, smart sensor networks, smart TV and smart advertisement, person re-identification, smart traffic monitoring, drones, and the like. Accordingly, when decoded data is consumed by machines, a quality metric for the decoded data may be defined, which may be different from a quality metric for human perceptual quality. Also, dedicated algorithms for compressing and decompressing data for machine consumption may be different than those for compressing and decompressing data for human consumption. The set of tools and concepts for compressing and decompressing data for machine consumption is referred to here as Video Coding for Machines.

It is likely that the receiver-side device has multiple ‘machines’ or neural networks (NNs). These multiple machines may be used in a certain combination which is for example determined by an orchestrator sub-system. The multiple machines may be used for example in succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of all the pixels in the frames.

Also, it is to be noted that the term ‘receiver-side’ or ‘decoder-side’ to refer to a physical or abstract entity or device which includes one or more machines, and runs these one or more machines on some encoded and eventually decoded video representation, which is encoded by another physical or abstract entity or device, the ‘encoder-side device’.

The encoded video data may be stored into a memory device, for example, as a file. The stored file may later be provided to another device.

Alternatively, the encoded video data may be streamed from one device to another.

The receiver or decoder-side device may have multiple ‘machines’ or neural networks (NNs) for analyzing or processing decoded data. These multiple machines may be used in a certain combination which is for example determined by an orchestrator sub-system. The multiple machines may be used for example in temporal succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of objects in the frames.

FIG. 8 illustrates a pipeline of video coding for machines (VCM), in accordance with an embodiment. A VCM encoder 802 encodes the input video into a bitstream 804. A bitrate 806 may be computed 808 from the bitstream 804 in order to evaluate the size of the bitstream 804. A VCM decoder 810 decodes the bitstream 804 output by the VCM encoder 802. An output of the VCM decoder 810 may be referred, for example, as decoded data for machines 812. This data may be considered as the decoded or reconstructed video. However, in some implementations of the pipeline of VCM, the decoded data for machines 812 may not have same or similar characteristics as the original video which was input to the VCM encoder 802. For example, this data may not be easily understandable by a human, if the human watches the decoded video from a suitable output device such as a display. The output of the VCM decoder 810 is then input to one or more task neural network (task-NN). For the sake of illustration, FIG. 8 is shown to include three example task-NNs, a task-NN 814 for object detection, a task-NN 816 for image segmentation, a task-NN 818 for object tracking, and a non-specified one, a task-NN 820 for performing task X. The goal of VCM is to obtain a low bitrate while guaranteeing that the task-NNs still perform well in terms of the evaluation metric associated with each task.

For an application where image/video coding is applied, some regions of the input frame may contain important information for the system, while other regions are less important. The regions that are important for the system may be referred to as regions of interest (ROIs) or foreground regions. Regions other than the foreground regions may be referred to as non-ROIs or background regions. Important regions for the system may, for example, be such that affect that machine analysis precision of a task network. For instance, when the system performs an object detection task, ROIs may include objects that are supposedly detected by the object detection task network.

Given the information of the ROIs as input, the encoder may encode the ROIs with higher qualities while encoding the non-ROIs with lower qualities. ROI-based encoding may refer to an encoding process, where only some region(s) of an image or a frame are encoded with a high-quality, while rest of the image or the frame is encoded with lower quality. ROI-based preprocessing may refer to preprocessing prior to encoding, where only some region(s) of an image or a frame are not preprocessed or are enhanced to have higher quality, while rest of the image or the frame may be preprocessed to have lower quality. For example, preprocessing may apply an edge-sharpening filter for ROIs and/or a smoothening filter for non-ROIs. The term “quality” in relation to ROI-based coding or preprocessing does not necessarily mean quality as perceived by human beings, and may additionally or alternatively mean “quality” as analyzed by a machine task, wherein higher quality may, for example, imply a higher machine analysis precision and lower quality may, for example, imply a lower machine analysis precision.

There are alternatives to detect regions of interest in the image or the frame, which comprise, e.g., feature-based algorithms, object-based algorithms, saliency-based algorithms, or their combination. For example, ROI detection may be performed using a task NN, such as an object detection NN or an instance segmentation NN.

Some ROI detection methods may provide a rectangular bounding box that includes one or more ROIs. Other ROI detection methods may provide boundaries of a region that may be non-rectangular. Some ROI-based encoding methods and some ROI-based preprocessing methods may expect rectangular ROIs, while others may operate with ROIs of any shape. Embodiments are not limited to rectangular ROIs unless specifically described.

When a conventional video encoder, such as a H.266/VVC encoder, is used as a VCM encoder, one or more of the following approaches may be used to adapt the encoding to be suitable to machine analysis tasks:
One or more regions of interest (ROIs) may be detected. An ROI detection method may be used. For example, ROI detection may be performed using a task NN, such as an object detection NN. In some cases, ROI boundaries of a group of pictures or an intra period may be spatially overlaid and rectangular areas may be formed to cover the ROI boundaries. The detected ROIs (or rectangular areas, likewise) may be used in one or more of the following ways:
   The quantization parameter (QP) may be adjusted spatially in a manner that ROIs are encoded using finer quantization step size(s) than other regions. For example, QP may be adjusted CTU-wise.
   The video is preprocessed to contain only the ROIs, while the other areas are replaced by one or more constant values or removed.
   A grid is formed in a manner that a single grid cell covers a ROI. Grid rows or grid columns that contain no ROIs are downsampled as preprocessing to encoding.
Quantization parameter of the highest temporal sublayer(s) is increased (e.g., coarser quantization is used) when compared to practices for human watchable video.
The original video is temporally downsampled as preprocessing prior to encoding. A frame rate upsampling method may be used as postprocessing subsequent to decoding, when machine analysis at the original frame rate is desired.
A filter is used to preprocess the input to the conventional encoder. The filter may be a machine learning based filter, such as a convolutional neural network.

The above-mentioned approaches to adapt the encoding to be suitable to machine analysis serve as examples. It is to be understood that embodiments may be applied with any of the above-mentioned approaches to adapt the encoding to be suitable to machine analysis tasks, but embodiments are not necessarily limited to only the above-mentioned approaches.

When video is preprocessed prior to encoding and/or encoded to be suitable for machine vision tasks, it might no longer be suitable for watching by human beings. Following are some example problems that various embodiments are related to:
Sometimes a certain spatial, temporal, or spatiotemporal part of the video is intended for machine vision tasks and/or is not suitable for watching, while the remaining spatial, temporal, or spatiotemporal part of the video may have the opposite property. How to indicate to a decoder device such spatial, temporal, or spatiotemporal parts?
How to indicate to a decoder device which type of pre-processing prior to encoding and/or encoding has the video undergone?
How to postprocess the decoded video so that the postprocessing conceals or counters the preprocessing and/or encoding and the postprocessed video becomes visually pleasing for human observation? How to indicate suitable postprocessing to the decoder?

It is to be understood that, in various embodiments, phrases such as ‘serve video to displaying’ or ‘serve video to machine analysis’ may imply that the video directly is provided as input to displaying or machine analysis, respectively, or that the video undergoes further processing prior to being provided as input to displaying or machine analysis, respectively. The further processing may, for example include but are not limited to, temporal upsampling, spatial upsampling, downsampling, chroma format conversion (e.g., from 4:2:0 to 4:4:4), and/or color space conversion (e.g., from YCbCr to RGB).

It is to be further understood that, in various embodiments, the terms ‘machine vision’, ‘machine vision task’, ‘machine task’, ‘machine analysis’, ‘machine analysis task’, ‘computer vision’, ‘computer vision task’, and ‘task’ may be used interchangeably.

It is to be further understood that, in various embodiments, the terms ‘machine consumption’ and ‘machine analysis’ may be used interchangeably.

It is to be further understood that, in various embodiments, the terms ‘machine-consumable’ and ‘machine-targeted’ may be used interchangeably.

It is to be further understood that, in various embodiments, the terms ‘user viewing’, ‘human observation’, ‘human perception’, ‘displaying’, ‘displaying to human beings’, ‘watching’, and ‘watching by human beings’ may be used interchangeably. Further, the term ‘user’, unless otherwise explicitly specified, includes a human user.

It is to be further understood that, in various embodiments, the term ‘subjective’ may imply ‘human perception’.

It is to be further understood that, in various embodiments, the terms ‘inconsistent’ and ‘incoherent’ may be used interchangeably.

It is to be further understood that, in various embodiments, the terms ‘post-filter’, ‘post-processing filter’ and ‘postprocessing filter’ may be used interchangeably.

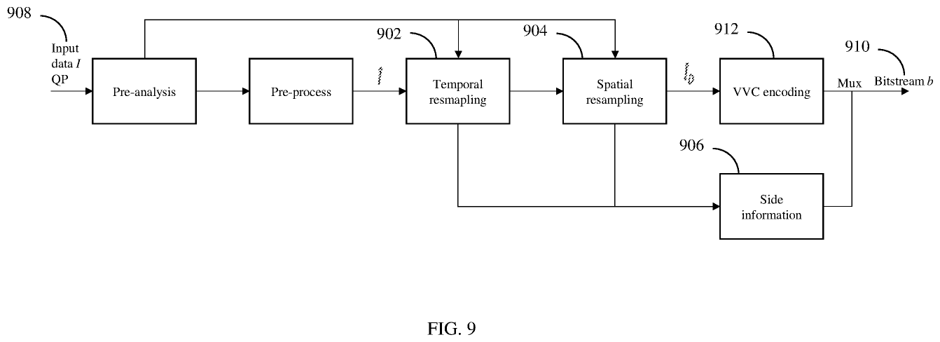

Referring to FIG. 9 it illustrates an encoder-side block diagram. The adaptive temporal process 902 and spatial resampling process 904 produce some side information 906 needed at a decoder for reconstruction, including the temporal resampling factor, spatial resampling ratio, and some metadata information of the input data 908 (e.g., height, width and frame number, and the like). The bitstream b 910 is obtained by multiplexing the VVC bitstream generated by VVC encoding process 912 and the side information 906.

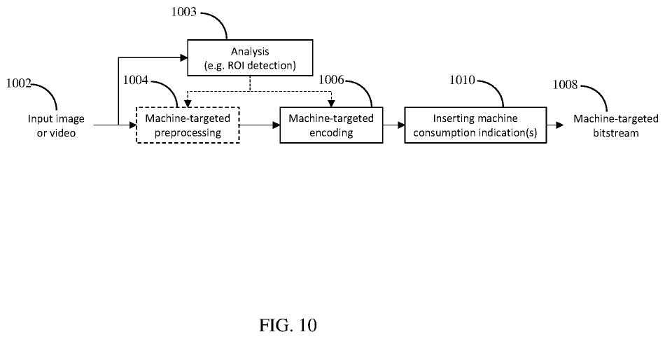

FIG. 10 illustrates an embodiment for encoding. Initially an input image or video 1002 may be analyzed by an analysis block or circuit 1003. For example, one or more regions of interest (ROIs) may be detected in the analysis. The results of analysis are provided as input to preprocessing block or circuit 1004 and/or encoding block or circuit 1006. The optional preprocessing block or circuit 1004 may process the image or video as described in previous sections. The encoding block or circuit 1006 may use results of the analysis to encode the image or video 1002 as described previous sections. As a result of the preprocessing or encoding, a bitstream 1008 is targeted for machine consumption and may not be suitable for watching by human beings. A machine consumption indication block or circuit 1010 inserts a machine consumption indication, hereafter referred to as a machine consumption indication SEI message, in the bitstream 1008. It may indicate that the video within the scope of the SEI message may be inconsistent or incoherent for human perception and/or that the video within the scope is intended for machine analysis.

In some embodiments, the encoding system may be configured to be targeted for machine consumption and the analysis block or circuit 1003 may be omitted. For example, preprocessing and/or encoding may be configured to produce encoded frames that have temporally varying quality.

Tasks performed by the analysis block or circuit 1003 may include, but may not be limited to, one or both of the following:
ROI detection, which may be performed, for example, by an object detection or instance segmentation method or NN;
objector ROI movement detection, which may be performed, for example, by an object tracking method or NN.

In an embodiment, object or ROI movement detection may be used to determine if a frame is encoded. If no substantial movement has been detected, it may be determined to exclude a frame from encoding, whereas if substantial movement has been detected, it may be determined to encode a frame.

Embodiments for encoding are realized by encoding and including further indications into a machine consumption SEI message. Embodiments for decoding are realized by decoding further indications from a machine consumption SEI message. The further indications may comprise, but may not be limited to, one or more of the following categories:
characterization of which type of degradation may be observed by user viewing;
characterization of the preprocessing step(s) prior to encoding that may cause degradations for user viewing;
characterization of the encoding method(s) and/or configuration(s) that may cause degradations for user viewing; or
characterization of the postprocessing step(s) that may be used to conceal or counter degradations the decoded video has for user viewing.

The term applied usage may be used to indicate how the decoded or post-filtered video is consumed or processed subsequent to decoding or post-filtering, respectively. For example, the applied usage may be machine consumption, which means that the decoded or post-filtered video is processed by a machine analysis task. In another example, the applied usage may be user viewing or displaying.

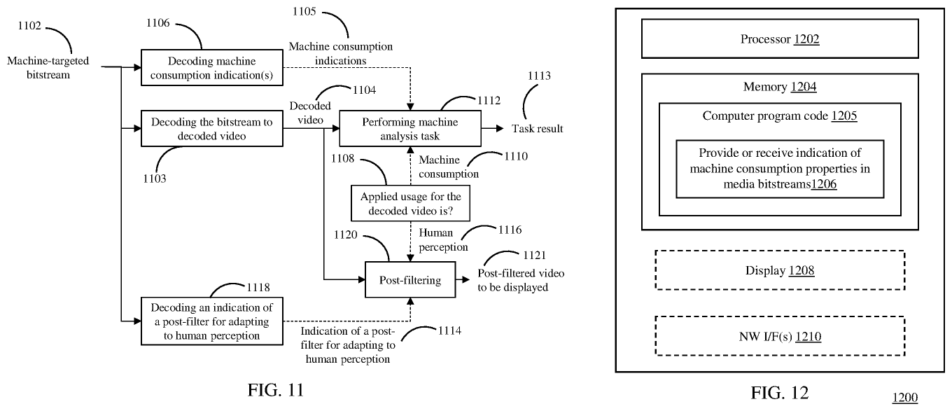

FIG. 11 illustrates an embodiment for decoding. An input bitstream (e.g., Machine-targeted bitstream 1102) is decoded 1103 to a decoded video 1104. As a part of or in connection with decoding the input bitstream 1102, machine consumption indication(s) 1105 are decoded 1106. When the applied usages 1108 for the decoded video 1104 include machine consumption 1110, a machine analysis task 1112 may be performed for the decoded video 1104 and a task result 1113 is provided as an example output. The machine consumption indications 1105 may affect the selection and/or configuration of the machine analysis task 1112. As a part of or in connection with decoding 1103 the input bitstream 1102, an indication of a post-filter for adapting 1114 the decoded video 1104 to human perception 1116 may be decoded 1118. When the applied usages 1108 of the decoded video 1104 include displaying the video to human beings, the decoded video 1104 is post-filtered 1120 with the indicated filter to generate, for example, post-filtered video to be displayed 1121. The indication of the post-filter 1114 may also include further characterization of the type(s) of the decoded video 1104 or bitstreams that it is suitable for.

Indicating that the Video is Intended for Machine Consumption

In an embodiment, a machine consumption indication SEI message has two syntax elements, wherein a first syntax element indicates the optimization or suitability for user viewing and a second syntax element indicates the optimization or suitability for machine consumption for the video within the persistence scope. Both the first and second syntax elements may, for example, have three possible values: i) the video has been optimized (e.g., through pre-processing and/or encoding) to, or has been made suitable for, user viewing or machine consumption (for the first or second syntax element, respectively), ii) the video may or may not be suitable for user viewing or machine consumption (for the first or second syntax element, respectively), and iii) the video is not suitable or is not suggested for user viewing or machine consumption (for the first or second syntax element, respectively). An encoder may indicate the value of case ii) for machine consumption, when it is unknown how the performed optimization for user viewing affects machine consumption. Alternatively or additionally, an encoder may indicate the value of case ii) for user viewing, when it is unknown how the performed optimized for machine consumption affects the quality perceived by users.

An example embodiment describes a suboptimal user viewing indication message. A suboptimal user viewing indication SEI message may be regarded as an alternative naming to a machine consumption indication SEI message. Embodiments for encoding and decoding may be realized with the proposed syntax and semantic of the suboptimal user viewing SEI message. The suboptimal user viewing indication SEI message indicates that the video resulting by decoding the current CLVS is not optimized for user viewing and may therefore look incoherent for user viewing.

The suboptimal user viewing indication SEI message may be used together with the SEI manifest SEI message. When an SEI manifest SEI message indicates that no suboptimal user viewing indication SEI message is expected to be present, the decoded video may be expected to be targeted for user viewing. When an SEI manifest SEI message indicates that suboptimal user viewing indication SEI message(s) are expected to be present and their handling is considered necessary, the decoded video may potentially look suboptimal for user viewing.

A suboptimal user viewing indication SEI message may be present in the first picture unit, in decoding order, within a CLVS that has a particular temporal sublayer identifier lowestTidInScope. For example, when a bitstream is encoded with an additional QP offset by 5 for frames with TemporalId greater than or equal to 2, a suboptimal user viewing indication SEI message is included in the first picture unit, in decoding order, within a CLVS that has TemporalId equal to 2 (thus, in this example, lowestTidInScope is equal to 2). Consequently, a sub-bitstream formed by picture units of TemporalId equal to 0 and 1 would not contain a suboptimal user viewing indication SEI message and would be considered subjectively coherent.

In an example, VSEI specification may include a suboptimal user viewing indication SEI message. An example proposal may include following:

### EXAMPLE IMPLEMENTATION

### Persistence Scope

TABLE 1
Persistence scope of SEI messages (informative)

| SEI message | Persistence scope |
|---|---|
| . . . | . . . |
| Suboptimal user | The CLVS containing the SEI message |
| viewing indication | |

In an embodiment, the payload size (payloadSize) of the suboptimal user viewing indication SEI message is 0. In other words, the suboptimal user viewing indication SEI message does not include any syntax elements.

In an embodiment, one or more syntax elements in the suboptimal user viewing indication SEI message indicates a type of incoherence or inconsistency that the decoded video may have for user viewing. An example of specifying the suboptimal user viewing indication SEI message including a syntax element for the type of incoherence or inconsistency for user viewing is presented below.

### Syntax

| | Descriptor |
|---|---|
| suboptimal_user_viewing_indication( payloadSize ) { | |
| suvi_incoherence_idc | ue(v) |
| } | |

### Semantics

The suboptimal user viewing indication SEI message indicates that the video resulting by decoding the current CLVS is not optimized for user viewing and may therefore look incoherent for user viewing.

In this example, the video is optimized for some other purpose than user viewing, such as a machine analysis task.

When a suboptimal user viewing indication SEI message is present for any picture of a CLVS, a suboptimal user viewing indication SEI message may be present in the first picture unit, in decoding order, within a CLVS that has a particular temporal sublayer identifier equal to tId and may be required to be absent in any other picture unit of the CLVS. When a suboptimal user viewing indication SEI message is present in a picture unit with tId greater than 0, the sequence of cropped decoded output pictures decoded from the picture units with temporal sublayer identifier less than tId is optimized in a manner that may be suitable for user viewing. The corresponding semantics of the syntax elements are defined as following:

suvi_incoherence_idc indicates the types of degradation for user viewing that may appear in the cropped decoded output pictures of the CLVS.

suvi_incoherence_idc equal to 0 indicates an unknown type of degradation for user viewing.

When (suvi_incoherence_ide & 1) is greater than 0, any cropped decoded output picture in the CLVS with temporal sublayer identifier greater than or equal to tId is optimized in a manner that may result in spatial incoherence for user viewing. When (suvi_incoherence_idc & 1) is equal to 0, any cropped decoded output picture in the CLVS with temporal sublayer identifier greater than or equal to tId should not result in spatial incoherence for user viewing.

When (suvi_incoherence_idc & 2) is greater than 0, the sequence of cropped decoded output pictures of the CLVS is optimized in a manner that may result in unpleasant temporal quality variation for user viewing. When (suvi_incoherence_idc & 2) is equal to 0, the sequence of cropped decoded output pictures of the CLVS is optimized in a manner that should not result in unpleasant temporal quality variation for user viewing.

When (suvi_incoherence_idc & 4) is greater than 0, the sequence of cropped decoded output pictures of the CLVS is optimized in a manner that may result in unpleasant picture rate variation for user viewing. When (suvi_incoherence_idc & 4) is equal to 0, the sequence of cropped decoded output pictures of the CLVS is optimized in a manner that should not result in unpleasant picture rate variation for user viewing.

In different embodiments for encoding or decoding, a machine consumption SEI message may comprise, but may not be limited to, one or more of the following:
An indication of which type(s) of inconsistency for human perception may be present in the video within the scope.
   In an embodiment, the types of inconsistency may comprise, but may not be limited to, one or more of the following:
      Spatial quality inconsistency, which may be defined as spatial picture quality fluctuations that may be perceivable or annoying for human perception;
      Temporal quality inconsistency, which may be defined as temporal picture quality fluctuations that may be perceivable or annoying for human perception;
      Spatial-semantic quality inconsistency, which may be defined as spatially varying quality for different instances of a certain class of objects appearing in a certain frame. This may occur when, for example, an object detector used for detecting ROIs fails (or is expected to fail) to detect all instances of a certain object class within a frame (this may happen for the smaller objects), thus those instances are (unintentionally) encoded with lower quality than the detected instances;
      Temporal-semantic quality inconsistency, which may be defined as temporally varying quality for instances of a certain class of objects appearing in different frames;
      Spatial sampling inconsistency, which may be defined as spatially varying sampling density that may be perceivable or annoying for human perception. For example, rectangular regions of the original picture may have been downsampled with different downsampling ratios;
      Temporal sampling inconsistency, which may be defined as picture rate changes that may be perceivable or annoying for human perception; or
      Spatiotemporal sampling inconsistency, which may be defined as temporal variation of the width and/or height of pictures that may be perceivable or annoying for human perception;
   In an embodiment, the types of inconsistency may comprise spatial inconsistency and temporal inconsistency. Spatial inconsistency comprises the spatial quality and sampling inconsistencies as defined above. Temporal inconsistency comprises the temporal quality and sampling inconsistencies as well as the spatiotemporal sampling inconsistency as defined above; or
   In an embodiment, the indication of which type(s) of inconsistency for human perception may be present in the video within the scope may be associated to an indication of one or more values representing the extent or level of inconsistency, for one or more of the indicated inconsistencies. In one example, where the indicated inconsistency is spatial quality inconsistency, the indicated one or more values comprise a PSNR difference between the average highest-quality region in a frame and the average lowest-quality region in a frame (where the average is computed over the frames of the video within the scope). In another example, where the indicated inconsistency is spatial quality inconsistency, the indicated one or more values comprise an identifier of a predefined range of PSNR difference values, where the identifier is used at decoder side to retrieve (e.g., from a look-up table) the respective range of PSNR difference values;
An indication that the video within the scope is intended for machine vision tasks;
An indication that the video within the scope is not suitable for watching by human beings;
An indication that the video within the scope has been preprocessed and/or encoded to be suitable for one or more general types of machine analysis, for which the SEI message may comprise one or more indications characterizing the general type. For example, the SEI message may comprise information indicative of one or more of the following:
   Whole-image task, e.g., a task analyzing the whole or substantially the whole image or a frame of a video. An example of such task is image classification;
   Person-oriented task, e.g., a task analyzing one or more aspects of persons appearing in one or more frames of the video. An example of such task is person detection. Another example of such task is pose estimation;
   Objects-oriented task, e.g., a task analyzing one or more aspects of objects appearing in one or more frames of the video; or
   Video task, e.g., a task analyzing two or more frames of a video. Tasks in this category may be sensitive to the absence of some frames in the decoded video, which may be caused by frame skipping or framerate downsampling performed at encoder side.
An indication that the video within the scope has been preprocessed and/or encoded to be suitable for one or more specific types of machine analysis. For example, the SEI message may comprise information indicative of one or more of the following:
   Image/frame classification;
   Object detection;
   Object tracking;
   Semantic/panoptic segmentation;
   Instance segmentation; or
   Action recognition.
An indication that the video within the scope has been preprocessed and/or encoded to keep the machine analysis precision and/or picture quality of certain types of objects (referred to as objects of interest) higher than the other parts of the video. The SEI message may further comprise information indicative of object types with higher machine analysis precision and/or picture quality than the other parts of the video. It may, for example, be indicated that the video within the scope has been preprocessed and/or encoded to enhance persons (or any indicated types of objects, such as cars, bikes, other vehicles). The preprocessing and/or encoding may, for example, enhance edges of objects of interest and/or keep the picture quality within the objects of interest higher than for other objects or areas. Object types may be identified based on, for example, one or more of the following:
   pre-defined type values;
   registered identifiers;
   unique identifiers, such as URIs;
   an identification of an object classification task network that defines the object classes that have higher machine analysis precision or picture quality, and one or more indexes that identify those object classes with respect to an ordered list of object classes (e.g., the list of probability estimates that may be output by an object classification neural network; or
   Identifiers of sets of objects of interest. For example, there may be two predefined sets of objects of interest, where a first set comprises the objects ‘person’, ‘bicycle’, ‘vehicle’, ‘building’, and where a second set comprises the objects ‘computer’, ‘screen’, ‘chair’, ‘table’. These two sets may be stored in a look-up table. The identifier may be a binary index that is used to retrieve a set from the look-up table;
In an embodiment, the indication indicates that the video within the scope has been preprocessed and/or encoded to keep the machine analysis precision and/or picture quality of certain types of objects lower than other parts of the video;
An indication that the video within the scope has been preprocessed and/or encoded to represent the background at a lower machine analysis precision and/or picture quality. In one example, background may be defined as any area not classified or detected as an object. In another example, background may be defined as any area that is not part of one or more object categories (e.g., objects of interest). In yet another example, background may be defined as any area whose estimated motion extent is below a certain threshold, where the threshold may be pre-defined or determined based on the picture content. In yet another example, background is ‘textured’ content, with a ‘grain’ size below a pre-defined or indicated size. The background may be preprocessed and/or encoded, e.g., in one or more of the following ways, and the SEI message may comprise information indicative of one or more of the following:
   The background is preprocessed by a blurring filter or alike;
   The background is encoded with coarser quantization than other parts of the video;
   The background is preprocessed by replacing the pixel values representing the background with a reduced set of pixel values, for example with a single pixel value; or
   The background is determined based on one or more texture properties, such as grain size, and/or based on one or more values, such as the grain size value;
An indication that the video within the scope has been preprocessed and/or encoded to represent the non-background regions at a higher machine analysis precision and may not be pleasant to be watched by human beings;
An indication that the video within the scope has been preprocessed and/or encoded to represent the inner part of one or more objects or object categories at a lower machine analysis precision and/or picture quality. Here, ‘inner part’ may refer to the image region that is delimited by an object's boundaries. In one example, the lower machine analysis precision and/or picture quality may be caused by predicting or copying pixels or blocks of pixels belonging to the inner part of an object from one or more reference frames without performing any prediction-residual compensation. In one example, the indication may indicate that the inner part of any detected object in a certain picture are represented at a lower quality. In another example, the indication may indicate that the inner part of objects belonging to one or more object categories are represented at a lower quality, and an indication about the one or more object categories may be comprised in the machine consumption SEI message. As a figurative example, the indication may indicate that the inner part of a detected cat is represented at a lower quality, where the inner part comprises mostly texture about the fur of the cat, which may not be as important as the shape, pose or other aspects of the cat for some machine vision tasks. Thus, this indication may be useful for a decoder device to determine whether a certain machine vision task would perform well on the video within the scope; for example, when a machine vision task relies on or analyzes the inner parts of objects, and the indication indicates that the video within the scope has been preprocessed and/or encoded to represent the inner part of one or more objects or object categories at a lower machine analysis precision and/or picture quality, the decoder device may determine that the machine vision task would not perform well on the video within the scope and thus the machine vision task may not be executed;
An indication that the video within the scope has been preprocessed by replacing objects with semantically equivalent objects. In an example embodiment, a preprocessor identifies human beings, extracts selected features of the identified human beings, such as joint locations and/or bone orientations of a human skeletal model, and uses a generative neural network to render an artificial human being that can be used to replace the identified human being as preprocessing. Such a process may be used for anonymization. In another example embodiment, a preprocessor detects an object of a particular type, and uses a generative neural network to render an artificial object of the same type to replace the detected object as preprocessing. The artificial object may be “easier” to compress, e.g., may provide better machine task performance with less bitrate compared to compressing the detected object.
An indication identifying one or more neural networks that have been used in preprocessing, such as a neural network used for detecting ROIs. For example, the indication may comprise a URI identifying the neural network and a tag URI identifying the representation format of the neural network;
An indication that the video within the scope (e.g., a certain picture) comprises one or more ROIs or objects of interest and thus the video within the scope (e.g., a whole picture) has been preprocessed and/or encoded to represent it at a higher machine analysis precision and/or picture quality;
An indication of which object categories were detected as part of a preprocessing operation, where the preprocessing operation may comprise, for example, detecting ROIs so that non-ROIs may be encoded at a lower quality, detecting ROIs so that non-ROIs may be encoded at a lower frame-rate, detecting ROIs so that the whole picture containing one or more ROIs may be encoded at a higher quality;
An indication identifying one or more confidence threshold values that have been used in preprocessing to determine whether the output of a certain preprocessing operation is reliable. In one example, where a preprocessing operation comprises object detection, the indication indicates a confidence threshold value that has been used for determining whether a detected object is considered as an ROI. For example, when the confidence of a detected object is above the indicated confidence threshold value, the detected object is considered as an ROI. In another example, where a preprocessing operation comprises object detection, the indication indicates two or more confidence threshold values, where each of the two or more confidence threshold values is associated to a detected object or to an object category;
An indication that the video within the scope has been captured and/or preprocessed and/or encoded to be suitable for one or more specific use cases or usage environments. Use cases or usage environments may be identified, e.g., through pre-defined type values, registered identifiers, or unique identifiers, such as URIs. Use cases or usage environments may be such that it may be preferred to analyze the video with computer vision task(s) rather than watching. Use cases or usage environments may include, but may not be limited to, one or more of the following:
   Night-time or low-light video;
   Dashboard camera (camera in a vehicle pointing forward to the road);
   Drone camera;
   Traffic camera;
   Camera for assembly line quality control or alike; or
   Non-visible light camera (e.g., near infrared light camera, long wave infrared camera);
An indication that the video within the scope may have been preprocessed and/or encoded so that the picture rate of the decoded output video may not be stable;
An indication that the video within the scope may have been preprocessed and/or encoded so that the picture rate of the decoded output video is lower than the original picture rate;
An indication that the video within the scope may have been preprocessed and/or encoded so that the picture quality may not be temporally stable (e.g., that the picture quality may have temporal quality fluctuations) to an extent that the video within the scope may not be preferred for watching;
An indication that the video within the scope may have been preprocessed and/or encoded so that one or more pre-defined or indicated aspects of the video content may fluctuate in time. In one example, it is indicated that the position of objects or object boundaries may slightly change across adjacent frames, in a different way than in the uncompressed video. In another example, it is indicated that the size of objects or object boundaries may slightly change across adjacent frames, in a different way than in the uncompressed video;
An indication that the video within the scope may have been preprocessed and/or encoded so that one or more pre-defined or indicated aspects of one or more machine vision outputs may fluctuate in time. In one example, where the machine vision task is object detection, the indication indicates that the position of boundaries of objects detected in decoded frames may slightly change across adjacent frames, in a different way than when detection is performed on the uncompressed video. In another example, it is indicated that the size of boundaries of objects detected in decoded frames may slightly change across adjacent frames, in a different way than when detection is performed on the uncompressed video;
An indication that the video within the scope may have been preprocessed and/or encoded so that the picture quality may not be spatially stable (e.g., that the picture quality may have spatial quality fluctuations) to an extent that the video within the scope may not be preferred for watching. For example, the video within the scope may have undergone smoothing or coarse quantization in spatial regions that have been assumed to be unimportant for machine analysis;
An indication that the video within the scope may have spatially varying resolution. For example, an original picture may be split to rectangular regions (e.g., ROIs and remaining regions) and the rectangular regions of an original picture may be downsampled in preprocessing (e.g., remaining regions may be downsampled to a lower resolution than ROIs) and packed to the same picture to be encoded;
An indication that the video within the scope may have been preprocessed and/or encoded to be suitable for computer vision tasks analyzing objects of an indicated size. The SEI message may comprise indications informative of the size, such as one or more of the following:
   A qualitative indication, e.g., ‘small objects’ or ‘big objects’;
   A size range of objects for which the video within the scope has been enhanced in preprocessing and/or encoding;
   A minimum size, expressed in pixel count, of objects for which the video within the scope has been enhanced in preprocessing and/or encoding; or
   An indication of an estimated average distance between the camera that captured the video within the scope and the captured objects;
An indication that the video within the scope has been preprocessed and/or encoded in a manner that enhances object edges. The SEI message may further comprise indications informative of the size of the objects whose edges have been enhanced, such as the following:
   A size range of objects whose edges have been enhanced in the video within the scope;
An indication identifying one or more parameters of a filter that has been used as part of a preprocessing operation applied to the video within the scope. In one example, the one or more parameters comprises an identifier of the filter. In another example, the one or more parameters comprises an identifier of a set of learned parameters of the filter (e.g., weights of a neural network filter, or parameters used to control an edge-enhancement filter);
An indication that the video within the scope may have been preprocessed and/or encoded in a manner that moving regions or objects have been enhanced for machine analysis precision and/or picture quality;
An indication that the video within the scope may have been preprocessed and/or encoded in a manner that one or more types of artifacts may be present in the pictures. The presented artifacts may include, but may not be limited to, one or more of the following:
   checker-board artifacts;
   edge ghosting artifacts;
   block boundary artifacts; or
   color distortion.
A first indication that the video within the scope has been temporally resampled and a second indication about the shutter interval or exposure time that the temporally resampled video has. In an example embodiment, an encoder downsamples the picture rate of the video intended for machine consumption. Since motion blur may hinder machine consumption performance, an encoder may choose to perform temporal downsampling by decimating the original picture sequence, in which case the shutter interval is kept unchanged. The encoder indicates with the first indication that the video within the scope has been temporally resampled (or more exactly, temporally downsampled), and indicates with the second indication that the shutter interval of the video is equal to the shutter interval of the original video. In another example embodiment, an encoder downsamples the picture rate of the video intended for user viewing. An encoder, for example, creates a merged picture by each non-overlapping pair of consecutive pictures by pixel-wise averaging. Consequently, the merged picture may comprise motion blur, and its shutter interval may be considered to be double of the original shutter interval. The encoder indicates with the first indication that the video within the scope has been temporally resampled (or more exactly, temporally downsampled), and indicates with the second indication that the doubled shutter interval value. The second indication may comprise several syntax elements, such as similar to those of the shutter interval information SEI message specified in the VSEI standard.

The determination of the video within the scope may be performed in, but may not be limited to, one or more of the following ways:
The video within the scope is determined by the pre-defined persistence of the machine consumption indication SEI message, such as until the end of the CLVS that includes the machine consumption indication SEI message;
The video within the scope is indicated with the presence of the machine consumption indication SEI message(s). For example, the temporal scope is from the picture unit comprising the machine consumption indication SEI message, inclusive, until the first one of any of the following:
   the end of the CLVS;
   the next machine consumption indication SEI message in the same CLVS, exclusive;
   a next machine consumption indication SEI message, in the same CLVS, that deactivates the machine consumption indication SEI message, exclusive;
The video within the scope is indicated in the machine consumption indication SEI message. For example, in an embodiment, spatial region(s) for the video within the scope is indicated through coordinates and/or width or height. In an embodiment, the machine consumption indication SEI message comprises information indicative of temporal sublayers that are intended for computer vision tasks and may not be suitable for human watching. Alternatively or additionally, the machine consumption indication SEI message comprises information indicative of temporal sublayers that are intended for human watching. For example, the machine consumption indication SEI message may comprise a syntax element, here referred to as suvi_min_tid, that indicates the smallest TemporalId where the video may look incoherent for human watching, also implying that a sub-bitstream formed by pictures with TemporalId less than suvi_min_tid would be suitable for human watching; Alternatively or additionally, the machine consumption indication SEI message comprises information indicative of temporal sublayers that have been optimized or are intended for machine consumption.
The video within the scope is indicated by the SEI NAL unit that comprises the machine consumption indication SEI message, for example, in one or both of the following ways:
   Layer identifier (nuh_layer_id) indicated in the NAL unit header indicates the (scalable) layer of the video within the scope; or
   Temporal sublayer identifier (TemporalId) that is derived from the NAL unit header and is greater than 0 indicates that a video decoded resulting from decoding a sub-bitstream that is formed from the picture units with temporal sublayer identifier less than TemporalId is not known to look incoherent for human perception;
The video within the scope is indicated by including the machine consumption indication SEI message in a scalable nesting SEI message, where the scalable nesting SEI message indicates a sub-bitstream that corresponds to the video within the scope. The scalable nesting SEI message may, for example, indicate (scalable) layers and/or temporal sublayers to which the machine consumption indication SEI message applies. Alternatively, the scalable nesting SEI message may, for example, indicate an operation point index to which the machine consumption indication SEI message applies;
The video within the scope may be indicated by including the machine consumption indication SEI message in a regional nesting SEI message, where the regional nesting SEI message indicates the region(s) that defines the video within the scope of the machine consumption indication SEI message.

In an embodiment, a machine consumption indication SEI message has two syntax elements, wherein a first syntax element indicates the optimization or suitability for user viewing and a second syntax element indicates the optimization or suitability for machine consumption for the video within the persistence scope, and an encoder encodes more than one machine consumption indication SEI message with different combinations of the first and second syntax element values. The machine consumption indication SEI messages may comprise information indicative of temporal sublayers that they apply, as discussed above. In an example embodiment, the encoder indicates in a first machine consumption indication SEI message that a first set of sublayers are suitable for user viewing and in a second machine consumption indication SEI message that a second set of sublayers is not suitable for user viewing, wherein the first set and the second set may be non-overlapping. The encoder may include the first and second machine consumption indication SEI messages in the same SEI NAL unit. For example, the encoder may increase the quantization parameter of the highest temporal sublayer(s) when compared to practices for human watchable video, and indicate in the second machine consumption indication SEI message that the highest temporal sublayer(s) are not suitable for user viewing. The encoder may use conventional quantization parameter settings for the lowest temporal sublayer(s) that are suitable for both user viewing and machine consumption, and indicate in the first machine consumption indication SEI message that the lowest temporal sublayer(s) are suitable for user viewing.

In an embodiment, a decoder or another entity decodes or infers the video within the scope of a machine consumption indication SEI message and decodes from the machine consumption indication SEI message that the video within the scope is intended for machine vision tasks. The decoder or another entity serves the decoded video within the scope to a machine task.

In an embodiment, a decoder or another entity decodes or infers the video within the scope of a machine consumption indication SEI message and decodes from the machine consumption indication SEI message that the video within the scope is suitable for watching by human beings. The decoder or another entity serves the decoded video within the scope to displaying.

In an embodiment, a decoder or another entity decodes or infers the video within the scope of a machine consumption indication SEI message and decodes from the machine consumption indication SEI message that one or more temporal sublayers of the video within the scope are intended for machine vision tasks. The decoder or another entity serves the decoded frames associated to the one or more temporal sublayers of the video within the scope to a machine task.

In an embodiment, a decoder or another entity decodes or infers the video within the scope of a machine consumption indication SEI message and decodes from the machine consumption indication SEI message that one or more temporal sublayers of the video within the scope are suitable for watching by human beings. The decoder or another entity serves the decoded frames associated to the one or more temporal sublayers of the video within the scope to displaying.

In an embodiment, a machine consumption indication SEI message is used together with the SEI manifest SEI message. When an SEI manifest SEI message indicates that no machine consumption indication SEI message is expected to be present, the decoded video may be expected to be suitable for human perception. When an SEI manifest SEI message indicates that machine consumption indication SEI message(s) are expected to be present and their handling is considered necessary, the decoded video can potentially look incoherent for human perception and/or may be considered to be intended for machine analysis.

In an embodiment, an encoder encodes an indication in or along a bitstream and/or a decoder decodes an indication from or along a bitstream that a spatiotemporal part of the bitstream is intended for machine consumption and/or may not be suitable for human watching. The spatiotemporal portion may, for example, be pre-defined or inferred to be a coded video sequence or a coded layer video sequence. In an embodiment, the indication is a syntax element, such as a flag, in video usability information (VUI). The flag may be called vui_non_machine_consumption_flag and its semantics may be specified as follows: vui_non_machine_consumption_flag equal to 1 specifies that there shall not be any machine consumption indication SEI messages present in the bitstream that apply to the CLVS. vui_non_machine_consumption_flag equal to 0 does not impose such a constraint.

### Indicating a Post-Filter Suitable for Processing Machine-Consumable Video to Become Suitable for Human Observation

In an embodiment, an encoder or another entity indicates, in or along a bitstream, one or more post-filters that are suitable to conceal or counter the preprocessing and/or encoding that were used in creation of the bitstream targeted for machine vision consumption so that the postfiltered video becomes visually pleasing for watching by human beings. In other words, the encoder or another entity indicates that the decoded video that may look inconsistent or incoherent for human perception can be post-filtered to become sufficiently consistent or coherent for human perception.

In an embodiment, a decoder or another entity decodes, from or along a bitstream, indication(s) of one or more post-filters that are suitable to conceal or counter the preprocessing and/or encoding that were used in creation of the bitstream targeted for machine vision consumption so that the postfiltered video becomes visually pleasing for watching by human beings. Subsequently, the decoder or another entity applies the indicated one or more post-filters to generate postfiltered video visually pleasing for watching by human beings.

In various embodiments, an indication of one or more post-filters, as described above, may be encoded in and/or decoded through one or more of the following means:
The post-filter may be identified in a machine consumption indication SEI message, e.g., with one of the following:
   An identifier value (which may be referred to as mci_conceal_pf_id) is included in the machine consumption indication SEI message and indicates that the post-filter is defined by the NNPFC SEI message(s) with nnpfc_id equal to mci_conceal_pf_id;
   A URI identifying the neural network and a tag URI identifying the representation format of the neural network, which may be included in a machine consumption indication SEI message; or
   The SEI message payload of one or more NNPFC SEI messages may be included in a machine consumption indication SEI message and define the post-filter;
The post-filter may be identified in an annotated regions SEI message with ar_not_optimized_for_viewing_flag equal to 1, e.g., similarly to described above for identifying a post-filter in a machine consumption indication SEI message.
The NNPFC SEI message may comprise information indicative that the postprocessing filter defined by the NNPFC SEI message is suitable to conceal or counter the preprocessing and/or encoding so that the postfiltered video becomes visually pleasing for human observation. For example, a specific value of the nnpfc_purpose syntax element may be used for indicating such postprocessing. In another example, a target use is indicated for the post-filtered video as described below; or
The NNPFA SEI message may comprise information indicative that the postprocessing filter activated by the NNPFA SEI message is suitable to conceal or counter the preprocessing and/or encoding so that the postfiltered video becomes visually pleasing for human observation.

In various embodiments, additional information related to the one or more post-filters, as described above, may be encoded in and/or decoded, wherein the additional information may comprise, but may not be limited to, one or more of the following:
The indicated post-filter may be associated to information indicative of which types of preprocessing and/or encoding it is capable of concealing or counter. In one example, such information may indicate that the post-filter is capable of concealing or countering spatially-varying quality. In another example, such information may indicate that the post-filter is capable of concealing or countering temporal resampling (e.g., by performing frame-rate upsampling);
The indicated post-filter may be associated to information indicative of how to filter different spatial, and/or temporal, and/or spatio-temporal regions. In one example, the associated information indicates the extent or amount of filtering for one or more spatial regions, where the information may comprise one or more values that are used for scaling an output of the post-filter or an internal signal of the post-filter. This way, regions that were preprocessed and/or encoded to be represented at a lower quality or machine precision may be filtered more heavily as compared to regions for consumption by the user;
The indicated post-filter may be associated to information indicative of whether the post-filter is to be used for filtering ROIs or non-ROIs. In one example, the post-filter is associated to a binary flag. When the binary flag is set to 1, it indicates that the post-filter is to be used on ROIs (regions intended for machine consumption) so that the filtered ROIs would be pleasant to be watched by human beings. When the binary flag is set to 0, it indicates that the post-filter is to be used on non-ROIs. In another example, the post-filter is associated to an identifier that can take at least three values. When the identifier is equal to 0, it indicates that the post-filter is to be used on ROIs (regions intended for machine consumption) so that the filtered ROIs would be pleasant to be watched by human beings. When the identifier is equal to 1, it indicates that the post-filter is to be used on non-ROIs. When the identifier is equal to 2, it indicates that the post-filter is to be used on both ROIs and non-ROIs; or
The indicated post-filter may be associated to information indicative of whether a visual domain adaptation is performed by the post-filter, and eventually which type of domain adaptation is performed. In one example, the video within the scope was recorded during night-time, the associated information indicates that the indicated post-filter performs a domain adaptation from night-time domain to day-time domain. Such a post-filter would then be selected by a decoder in case the machine vision task to be applied on the decoded (and eventually filtered) video within the scope works optimally on day-time video data. Other examples of visual domains include foggy weather (the postfilter could perform dehazing), rainy weather, average distance of camera from objects (the postfilter could perform zooming in), camera pose/angle (the postfilter could perform a re-projection to a more optimal camera pose), and the like.

In an embodiment, a decoder or another entity decodes or infers the video within the scope of a machine consumption indication SEI message and decodes from the machine consumption indication SEI message that the video within the scope is intended for machine vision tasks. The decoder or another entity further decodes indication(s) of one or more post-filters that are suitable to conceal or counter the preprocessing and/or encoding so that the postfiltered video becomes visually pleasing for watching by human beings. The decoder or another entity applies the post-filter to the decoded video within the scope and serves the post-filtered video to displaying.

### Indicating a Target Use for Post-Filtered Video

Some postprocessing filters defined for the bitstream may make the post-filtered video more suitable for machine analysis tasks. Their aim may be to improve the machine analysis precision. On the other hand, some postprocessing filters defined for the bitstream may make the post-filtered video more pleasing for watching by human beings. In addition, some postprocessing filters defined for the bitstream may aim at improving both the machine analysis precision and subjective quality.

In an embodiment, an encoder or another entity indicates, in or along a bitstream, one or more target usage(s) for post-filtered video resulting from a postprocessing filter.

In an embodiment, an encoder or another entity indicates, in an NNPFC SEI message or alike, one or more target usage(s) for post-filtered video resulting from the postprocessing filter defined by the NNPFC SEI message or alike.

In an embodiment, a decoder or another entity decodes, from or along a bitstream, one or more target usage(s) for post-filtered video resulting from a postprocessing filter.

In an embodiment, a decoder or another entity decodes, from an NNPFC SEI message or alike, one or more target usage(s) for post-filtered video resulting from the postprocessing filter defined by the NNPFC SEI message or alike.

Methods to indicate a target usage in the syntax may include, but may not be limited to, one or more of the following:
Values and their semantics that are pre-defined, e.g., in a standard;
Bit positions that indicate target usage, e.g., bit 0 in a target usage syntax element, when equal to 1, may indicate user viewing, and bit 1 in the target usage syntax element, when equal to 1, may indicate machine analysis;
Text string; or
Unique identifier, such as URI, that identifies a target usage.

In an embodiment, several target usage(s) are indicated in or along a bitstream, or decoded from or along a bitstream, through an array or loop of target usage syntax elements.

An example embodiment of adding the target usage indication in the NNPFC SEI message is described below.

This example defines the target usage of a post-processing filter to indicate whether the filtered video is suitable for any usage, is intended for user viewing, or is expected to be provided as input to machine analysis. It is proposed to add the target usage syntax element in the neural-network post-filter characteristics (NNPFC) SEI message.

The target usage is intended to be used for post-filter selection as follows: when the decoding device either displays the video or uses the video as input machine analysis opposite to what is indicated in the target usage of an NNPFC SEI message, the decoding device omits the post-processing filter defined by the NNPFC SEI message. Consequently, the target usage indication may be used to avoid post-filtering that would make the filtered video worse than the unfiltered video for the applied usage.

### Example Implementation

### Syntax

| | Descriptor |
|---|---|
| nn_post_filter_characteristics( payloadSize ) { | |
| nnpfc_id | ue(v) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| nnpfc_formatting_and_purpose_flag | u(1) |
| if( nnpfc_formatting_and_purpose_flag ) { | |
| nnpfc_target_usage | ue(v) |
| nnpfc_purpose | ue(v) |
| ... | |

The corresponding semantics of the syntax elements are defined as following:

nnpfc_target_usage indicates the intended usage of the filtered output sample arrays resulting from the post-processing filter as specified in Table 2 below. The filtered output sample arrays may undergo further processing, such as colour space conversion, prior to the intended usage.

TABLE 2
Definition of nnpfc_target_usage

| | Intended usage of the filtered output sample arrays |
|---|---|
| Value | resulting from the post-processing filter |
| 0 | Any usage |
| 1 | User viewing |
| 2 | Machine analysis |

When nnpfc_target_usage is equal to 1, the post-processing filter is intended to improve fidelity but may have a negative impact on machine analysis precision. When nnpfc_target_usage is equal to 2, the post-processing filter is intended to improve machine analysis precision but may have a negative impact on subjective quality.

When a decoding device displays the video for user viewing rather than performs machine analysis, any post-processing filter that has nnpfc_target_usage equal to 2 is suggested to be omitted. When a decoding device performs machine analysis rather than displays the video, any post-processing filter that has nnpfc_target_usage equal to 1 is suggested to be omitted.

In an embodiment, the decoder or another entity obtains one or more applied usage(s) for post-filtered video. For example, the decoder or another entity may be given applied usage(s) as an input parameter. The decoder or another entity concludes from the target usage(s) and applied usage(s) whether the postprocessing filter is suitable for the applied usage(s). For example, one or more usages may be represented by respective one or more predefined identifiers, and the concluding whether the postprocessing filter is suitable for the applied usage may comprise determining that the identifier representing the applied usage is equal to the identifier representing the target usage. In response to the postprocessing filter being suitable for the applied usage(s), the decoder executes the postprocessing filter. The decoder or another entity may provide the post-filtered video as input to perform operations or processes of the applied usage(s).

In embodiments, the target usage(s) may comprise, but may not be limited to, one or more of the following:
Unspecified, unknown, or determined by the application;
Universal for any target usage;
Human perception or displaying; or
Machine analysis.

Embodiments may be realized with different syntax for including target usage(s) in the NNPFC SEI message or alike, comprising but not limited to the following:
A bit mask, where each target usage has a specific bit position and the value of the bit indicates whether the target usage applies. For example, bit position 0 may indicate human perception and bit position 1 may indicate machine analysis;
A syntax element the value of which indicates the target usage. For example, value 0 may indicate any target usage, value 1 may indicate human perception, and value 2 may indicate machine analysis; or
A list of syntax elements, each identifying a target usage. The value of the syntax element may be an identifier of the target usage, which may be, e.g., an unsigned integer with pre-defined assignments or a URI.

In an embodiment, when a target usage is indicated to be human perception and the decoded video is indicated to be for machine consumption, it is concluded that the postprocessing filter makes a machine-targeted bitstream to become suitable for human perception.

In embodiments, the machine analysis target usage may be further characterized by one or more indications, which may be encoded by an encoder or another entity; or decoded by a decoder or another entity. These indications may comprise, but may not be limited to, one or more of the following:
An indication that the post-filtered video is intended to be suitable for one or more general types of machine analysis, for which the SEI message may comprise one or more indications characterizing the general type. Examples of general types are provided above;
An indication that the post-filtered video is intended to be suitable for one or more specific types of machine analysis. Examples of specific types of machine analysis are provided above;
One or more identifiers of task NNs that the post-filtered video is suitable for. An identifier may, for example, comprise a URI; or
An indication that the post-filtered video is intended to be suitable for a certain type of model/architecture of task-NN, which may comprise, but may not be limited to, one or more of the following:
   Transformer-based;
   CNN-based; or
   RNN-based;
An indication that the post-filtered video is intended to improve the machine analysis precision and/or picture quality of certain types of objects (referred to as objects of interest) more than the other parts of the video. The SEI message may further comprise information indicative of object types with improved machine analysis precision and/or picture quality. Examples of indications for object types are provided above;
An indication that the post-filtered video is intended to lower the machine analysis precision and/or picture quality of background. The intent of such post-filtering may be, for example, to reduce the number of false positives detected from the background. The background may be defined as described above. The SEI message may further comprise information characterizing the processing of the background, which may comprise, but may not be limited to, the following:
   Indication of the type of background filtering, such as blurring;
An indication that the post-filtered video is intended to process the inner part of one or more objects or object categories at a lower machine analysis precision and/or picture quality. The inner part may be defined as described above. The SEI message may further comprise one or more object categories that are subject to post-filtering;
An indication that the post-filtered video is intended to be suitable for one or more specific use cases or usage environments. Use cases or usage environments may be identified as described above. Use cases or usage environments may be such that it may be preferred to analyze the video with computer vision task(s) rather than watching. Examples of use cases or usage environments are described above;
An indication of camera extrinsic parameters relative to objects for which the postprocessing filter is suitable. The camera extrinsic parameters may be derived from the training dataset used to train the post-filter NN. For example, there may be several training datasets for drone vision, captured at specific altitudes and angles. The relative camera extrinsic parameters may comprise, but may not be limited to, one or more of the following: altitude of camera, angle/pose of camera, moving camera and type of movement (e.g., rotational, or forward, or mixed), closeness to objects of interest (e.g., in industrial inspection and quality control the camera is close to the monitored objects);
An indication that the postprocessing filter is intended to make the picture rate stable for machine analysis at a stable picture rate;
An indication that the postprocessing filter is suitable for task-NNs analyzing videos (e.g., the postfilter guarantees a certain level of temporal consistency). For example, a multi-frame postfilter may be suitable for video analysis as it can guarantee some level of temporal consistency. Examples of video analysis tasks comprise, but may not be limited to, one or more of the following: action/activity classification/detection, object tracking, video semantic segmentation;
An indication that the postprocessing filter is suitable for image analysis tasks or task-NNs analyzing individual frames. An example of image analysis tasks comprises object detection;
An indication that the post-filtered video is intended to be suitable for computer vision tasks analyzing objects of an indicated size. The SEI message may comprise indications informative of the size as described above;
An indication that the postprocessing filter enhances object edges. The SEI message may further comprise indications informative of the size of the objects whose edges are enhanced, as described above;
An indication that the postprocessing filter enhances moving regions or objects for machine analysis precision and/or picture quality;
An indication that the postprocessing filter does not modify pre-defined or indicated characteristics of objects. Consequently, the post-filtered video may be given as input to tasks that rely on those characteristics. Examples of such characteristics comprise, but may not be limited to, the following:
   Affine transformations such as scaling (magnifying objects) and/or changing the relative position of objects, which may be important for a social distancing monitoring task; or
   Absolute object positions, which may be important when pre-processing for encoding has removed some frames and the postfilter performs frame rate upsampling to reconstruct original frame rate. This indication may further be characterized by one or both of: maximum object position difference and object type;
An indication of an expected gain according to the pre-defined or indicated metrics of the post-filtered video relative to the decoded video; or
An indication that the postprocessing filter reduces or mitigates one or more types of artifacts. The SEI message may further comprise indications informative of the characteristics of the artifacts that the filter is effective, for example, the size of the blocks of a checkerboard artifacts, or the intensity range of a type of artifacts.

In the above examples or embodiments, when an indication is associated with the post-filtered video, it may alternatively or additionally be associated with the post-filter and vice-versa.

FIG. 12 is an example apparatus 1200, which may be implemented in hardware, caused to provide or receive indication of machine consumption properties in video bitstreams, based on the examples described herein. The apparatus 1200 comprises at least one processor 1202, at least one non-transitory memory 1204 including computer program code 1205, wherein the at least one memory 1204 and the computer program code 1205 are configured to, with the at least one processor 1202, cause the apparatus 1200 to provide indication of machine consumption properties in video bitstreams 1206, based on the examples described herein

The apparatus 1200 optionally includes a display 1208 that may be used to display content during rendering. The apparatus 1200 optionally includes one or more network (NW) interfaces (I/F(s)) 1210. The NW I/F(s) 1210 may be wired and/or wireless and communicate over the Internet/other network(s) via any communication technique. The NW I/F(s) 1210 may comprise one or more transmitters and one or more receivers. The N/W I/F(s) 1210 may comprise standard well-known components such as an amplifier, filter, frequency-converter, (de)modulator, and encoder/decoder circuitry(ies) and one or more antennas.

The apparatus 1200 may be a remote, virtual or cloud apparatus. The apparatus 1200 may be either a coder or a decoder, or both a coder and a decoder. The at least one memory 1204 may be implemented using any suitable data storage technology, such as semiconductor based memory devices, flash memory, magnetic memory devices and systems, optical memory devices and systems, fixed memory and removable memory. The at least one memory 1204 may comprise a database for storing data. The apparatus 1200 need not comprise each of the features mentioned, or may comprise other features as well. The apparatus 1200 may correspond to or be another embodiment of the apparatus 50 shown in FIG. 1 and FIG. 2, any of the apparatuses shown in FIG. 3, or apparatus 700 of FIG. 7. The apparatus 1200 may correspond to or be another embodiment of the apparatuses shown in FIG. 12, including UE 110, RAN node 170, or network element(s) 190.

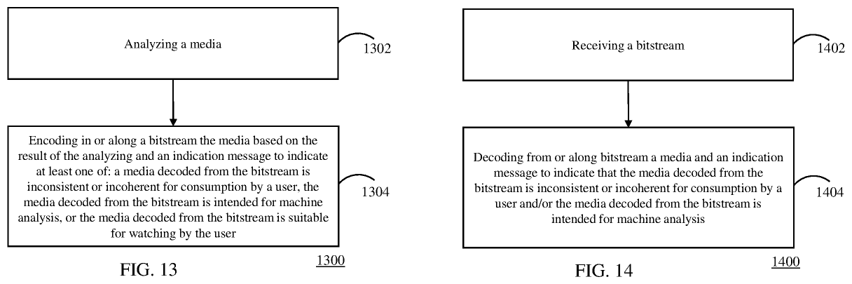

FIG. 13 is an example method 1300 to implement the examples described herein, in accordance with an embodiment. At 1302, the method 1300 includes analyzing a media. At 1304, the method 1300 includes encoding in or along a bitstream the media based on the result of the analyzing and an indication message to indicate at least one of: a media decoded from the bitstream is inconsistent or incoherent for consumption by a user, the media decoded from the bitstream is intended for machine analysis, or the media decoded from the bitstream is suitable for watching by the user. An example of the indication message includes, but is not limited to, as an indication supplemental enhancement information (SEI) message. Some examples of media include, but are not limited to, haptics, audio, video, and images. Some examples of consumption include, but are not limited to, viewing, listening, or combination thereof.

In an embodiment, the indication message may include a machine consumption indication message or a suboptimal user consumption indication message. An example of the machine consumption indication message includes, but is not limited to, to a machine consumption indication SEI message. An example of the suboptimal user consumption indication, but is not limited to, a suboptimal user viewing indication SEI message.

In an embodiment, the 1300 may further include comprising preprocessing the media, where the preprocessing may include: adjusting a quantization parameter (QP) spatially in a manner that one or more regions of interests (ROIs) in the media are encoded using finer quantization step size(s) than other regions, wherein analyzing the media comprises detecting the one or more ROIs in the media; including the one or more ROIs in the preprocessed media, while the other areas are replaced by one or more constant values or removed; forming a grid, wherein a single grid cell covers a ROI of the one or more ROIs and downsampling grid rows or grid columns that do not include an ROI; increasing quantization parameter of one or more highest temporal sublayer when compared to practices for media watchable by the user; downsampling the media temporally; and/or using a filter to preprocess the media.

The method 1300 may be performed with an apparatus described herein, for example, the apparatus 700, the apparatus 1200, or any apparatus as described in FIG. 16.

FIG. 14 is an example method 1400 to implement the examples described herein, in accordance with another embodiment. At 1402, the method 1400 includes receiving a bitstream. At 1404, the method 1400 decoding from or along bitstream a media and an indication message to indicate that the media decoded from the bitstream is inconsistent or incoherent for consumption by a user and/or the media decoded from the bitstream is intended for machine analysis. An example of the indication message includes, but is not limited to, as an indication supplemental enhancement information (SEI) message. Some examples of media include, but are not limited to, haptics, audio, video, and images. Some examples of consumption include, but are not limited to, viewing, listening, or combination thereof.

In an embodiment, the indication message may include a machine consumption indication message or a suboptimal user consumption indication message. An example of the machine consumption indication message includes, but is not limited to, to a machine consumption indication SEI message. An example of the suboptimal user consumption indication, but is not limited to, a suboptimal user viewing indication SEI message.

The method 1400 may be performed with an apparatus described herein, for example, the apparatus 700, the apparatus 1200, or any apparatus as described in FIG. 16.

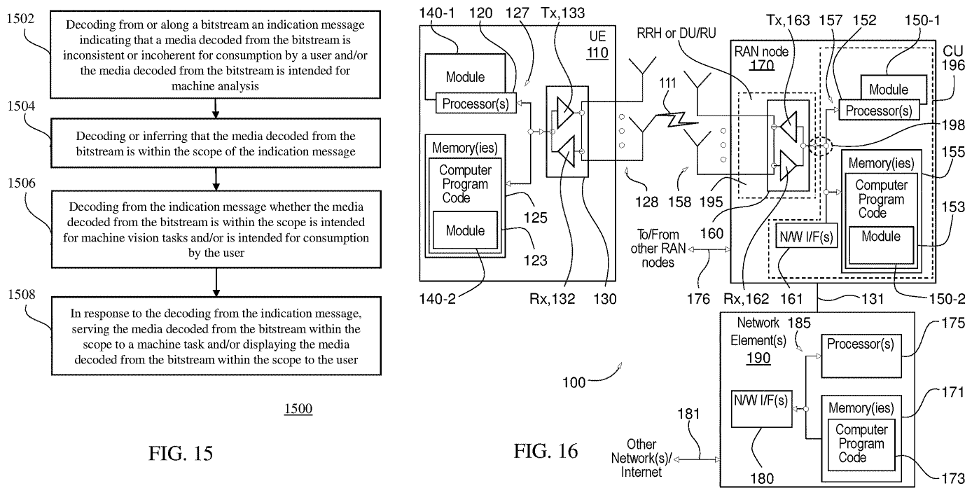

FIG. 15 is an example method to implement the embodiments described herein, in accordance with yet another embodiment. At 1502, the method 1500 includes decoding from or along a bitstream an indication message indicating that a media decoded from the bitstream is inconsistent or incoherent for consumption by a user and/or the media decoded from the bitstream is intended for machine analysis. At 1504, the method 1500 includes decoding or inferring that the media decoded from the bitstream is within the scope of the indication message. At 1506, the method 1500 includes decoding from the indication message whether the media decoded from the bitstream within the scope is intended for machine vision tasks and/or is intended for consumption by the user. At 1508, the method 1500 includes, in response to the decoding from the indication message, serving the media decoded from the bitstream within the scope to a machine task and/or displaying the media decoded from the bitstream within the scope to the user. For example, when it is decoded from the indication message that the media decoded from the bitstream within the scope is intended for machine vision tasks, the media decoded from the bitstream within the scope is served to the machined task; and when it is decoded from the indication message that the media decoded from the bitstream within the scope is intended for consumption by the user, the media decoded from the bitstream within the scope is displayed to the user. In an embodiment, serving the media decoded from the bitstream within the scope to a machine task and displaying the media decoded from the bitstream within the scope to the user are mutually exclusive.

In an embodiment, the method 1500 may further include decoding from the indication message that one or more temporal sublayers of the media decoded from the bitstream within the scope are intended for machine vision tasks; and serving decoded frames associated to one or more temporal sublayers of the media decoded from the bitstream within the scope to a machine task.

In an alternate or additional embodiment, the method 1500 may further include decoding from the indication message that one or more temporal sublayers of the media decoded from the bitstream within the scope are intended for machine vision tasks; and serving decoded frames associated to one or more temporal sublayers of the media decoded from the bitstream within the scope to a machine task.

The method 1500 may be performed with an apparatus described herein, for example, the apparatus 700, the apparatus 1200, or any apparatus as described in FIG. 16.

Referring to FIG. 16, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting radio resource control (RRC), SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, for example, as part of a RU, but some examples of this may have the transceiver 160 as part of a separate RU, for example, under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, for example, link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (for example, a central unit (CU), gNB-CU) of the RAN node 170 to the RRH/DU 195. Reference 198 also indicates those suitable network link(s).

It is noted that description herein indicates that ‘cells’ perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (for example, the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely example functions that may be supported by the network element(s) 190, and note that both 5G and LTE functions might be supported. The RAN node 170 is coupled via a link 131 to the network element 190. The link 131 may be implemented as, for example, an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

One or more of modules 140-1, 140-2, 150-1, and 150-2 may be configured for providing and/or receiving indication of machine consumption properties in video bitstreams. Computer program code 173 may also be configured for providing and/or receiving indication of machine consumption properties in video bitstreams.

As described above, FIGS. 13 to 15 include a flowchart of an apparatus (e.g., 50, 100, 602, 604, 700, or 1200), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g., 58, 125, 704, or 1204) of an apparatus employing an embodiment of the present invention and executed by processing circuitry (e.g., 56, 120, 702, or 1202) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowchart(s) of FIGS. 13 to 15. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

In the above, some embodiments have been described with reference to specific SEI messages, such as NNPFC SEI message(s) and/or NNPFA SEI message(s). It needs to be understood that embodiments can be similarly realized with any SEI messages of similar nature. For example, some embodiments may be realized with post-filter characteristics and/or activation SEI message(s) where post-filters are not based on neural networks.

In the above, some example embodiments have been described with reference to an SEI message or an SEI NAL unit. It needs to be understood, however, that embodiments can be similarly realized with any similar structures or data units, such as metadata OBUs. Where example embodiments have been described with SEI messages included in a structure, any independently parsable structures could likewise be used in embodiments. Specific SEI NAL unit and a SEI message syntax structures have been presented in example embodiments, but it needs to be understood that embodiments generally apply to any syntax structures with a similar intent as SEI NAL units and/or SEI messages.

In the above, some embodiments have been described in relation to machine analysis of video and/or user viewing. It to be understood that embodiments similarly apply to other modalities, such as haptics or audio. For example, embodiments may be realized in relation to machine analysis of audio and/or user listening.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, and the like.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This description of ‘circuitry’ applies to uses of this term in this application. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

Circuitry or Circuit: As used in this application, the term ‘circuitry’ or ‘circuit’ may refer to one or more or all of the following:
(a) hardware-only circuit implementations (such as implementations in only analog and/or digital circuitry); and
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

1-27. (canceled)

28. A method comprising:
analyzing a media; and
encoding in or along a bitstream the media based on a result of the analyzing
and an indication message to indicate at least one of: a media decoded from the bitstream is inconsistent or incoherent for consumption by a user, the media decoded from the bitstream is intended for machine analysis, or the media decoded from the bitstream is suitable for watching by the user.

29. The method of claim 28, wherein analyzing the media comprises detecting one or more objects in the media and considering background to comprise areas outside the one or more objects, and encoding comprises one or more object-based methods comprising:
preprocessing the media by including the one or more objects in the preprocessed media, while the background is replaced by one or more constant values or removed;
preprocessing the media forming a grid, wherein a single grid cell covers an object of the one or more objects and downsampling grid rows or grid columns that do not include the object;
preprocessing the background by a blurring filter; and/or
encoding the background with coarser quantization than the one or more objects;
wherein the indication message further comprises information indicative of the one or more object-based methods.

30. The method of claim 28 further comprising: downsampling the media temporally, wherein the indication message further comprises: an indication that the media has been preprocessed and/or encoded so that a picture rate of the decoded output media is lower than an original picture rate.

31. The method of claim 28 further comprising: increasing quantization parameter of one or more highest temporal sublayers when compared to practices for media watchable by the user.

32. The method of claim 28, wherein the indication message comprises a machine consumption indication message.

33. The method of claim 31, wherein the indication message further comprises: an indication that the media has been preprocessed and/or encoded so that a picture quality is not temporally stable to an extent that the output media is not suitable for watching by the user.

34. The method of claim 31, wherein the indication message further comprises: information indicative of temporal sublayers that are intended for computer vision tasks.

35. A method comprising
decoding from or along a bitstream an indication message indicating that a media decoded from the bitstream is inconsistent or incoherent for consumption by a user and/or the media decoded from the bitstream is intended for machine analysis;
decoding or inferring that the media decoded from the bitstream is within a scope of the indication message;
decoding from the indication message whether the media decoded from the bitstream within the scope is intended for machine vision tasks and/or is intended for consumption by the user; and
in response to the decoding from the indication message, serving the media decoded from the bitstream within the scope of a machine task and/or displaying the media decoded from the bitstream within the scope of the user.

36. The method of claim 35 further comprising:
decoding from the indication message that one or more temporal sublayers of the media decoded from the bitstream within the scope are intended for machine vision tasks; and
serving decoded frames associated with the one or more temporal sublayers of the media decoded from the bitstream is within the scope of the machine task.

37. The method of claim 35 further comprising:
decoding from the indication message that one or more temporal sublayers of the media decoded from the bitstream within the scope are suitable for watching by the user; and
serving decoded frames associated with the one or more temporal sublayers of the media decoded from the bitstream within the scope of displaying.

38. An apparatus comprising:
at least one processor; and at least one memory storing instructions that, when executed by the at least one processor, cause the apparatus at least to perform:
analyzing a media; and
encoding in or along a bitstream the media based on a result of the analyzing
and an indication message to indicate at least one of: a media decoded from the bitstream is inconsistent or incoherent for consumption by a user, the media decoded from the bitstream is intended for machine analysis, or the media decoded from the bitstream is suitable for watching by the user.

39. The apparatus of claim 38, wherein to perform analyzing the media, the apparatus is further caused to perform: detecting one or more objects in the media and considering background to comprise areas outside the one or more objects, and wherein to perform encoding, the apparatus is further caused to perform one or more object-based methods comprising:
preprocessing the media by including the one or more objects in the preprocessed media, while the background is replaced by one or more constant values or removed;
preprocessing the media forming a grid, wherein a single grid cell covers an object of the one or more objects and downsampling grid rows or grid columns that do not include the object;
preprocessing the background by a blurring filter; and/or
encoding the background with coarser quantization than the one or more objects;
wherein the indication message further comprises information indicative of the one or more object-based methods.

40. The apparatus of claim 38, wherein the apparatus is further caused to perform: downsampling the media temporally, wherein the indication message further comprises: an indication that the media has been preprocessed and/or encoded so that a picture rate of the decoded output media is lower than an original picture rate.

41. The apparatus of claim 38, wherein the apparatus is further caused to perform: increasing quantization parameter of one or more highest temporal sublayers when compared to practices for media watchable by the user.

42. The apparatus of claim 38, wherein the indication message comprises a machine consumption indication message.

43. The apparatus of claim 41, wherein the indication message further comprises: an indication that the media has been preprocessed and/or encoded so that a picture quality is not temporally stable to an extent that the output media is not suitable for watching by the user.

44. The apparatus of claim 41, wherein the indication message further comprises: information indicative of temporal sublayers that are intended for computer vision tasks.

45. An apparatus comprising:
at least one processor; and at least one memory storing instructions that, when executed by the at least one processor, cause the apparatus at least to perform:
decoding from or along a bitstream an indication message indicating that a media decoded from the bitstream is inconsistent or incoherent for consumption by a user and/or the media decoded from the bitstream is intended for machine analysis;
decoding or inferring that the media decoded from the bitstream is within a scope of the indication message;
decoding from the indication message whether the media decoded from the bitstream within the scope is intended for machine vision tasks and/or is intended for consumption by the user; and
in response to the decoding from the indication message, serving the media decoded from the bitstream within the scope of a machine task and/or displaying the media decoded from the bitstream within the scope of the user.

46. The apparatus of claim 45, wherein the apparatus is further caused to perform:
decoding from the indication message that one or more temporal sublayers of the media decoded from the bitstream within the scope are intended for machine vision tasks; and
serving decoded frames associated with the one or more temporal sublayers of the media decoded from the bitstream within the scope of the machine task.

47. The apparatus of claim 45, wherein the apparatus is further caused to perform:
decoding from the indication message that one or more temporal sublayers of the media decoded from the bitstream within the scope are suitable for watching by the user; and
serving decoded frames associated with the one or more temporal sublayers of the media decoded from the bitstream within the scope of displaying.
